(19) United States
(12) Patent Application Publication
(10) Pub. No.: US 2016/0321583 A1
(43) Pub. Date: Nov. 3, 2016

(54) Change navigation toolkit

(71) Applicants: Elizabeth C. Jones, Dallas, TX (US); Charles E. Mihaliak, Annandale, VA (US)

(72) Inventors: Elizabeth C. Jones, Dallas, TX (US); Charles E. Mihaliak, Annandale, VA (US)

(21) Appl. No.: 10/210,299

(22) Filed: Aug. 1, 2002

(51) Int. Cl. G06Q 10/06; G06F 3/0481; G06F 17/22; G06F 3/0482; G06F 17/24

(52) U.S. Cl. CPC G06Q 10/0637; G06F 3/0482; G06F 17/248; G06F 17/2235; G06F 3/04817

(57) ABSTRACT

A system and method are provided for managing the transition of a business organization from an existing operational environment to a target operational environment using an interactive implementation toolkit. The target operational environment uses an automated computer system running business processing software for carrying-out a business transaction process. The system and method include defining the target operational environment within the business organization and a corresponding course of action required to transition the business organization from the existing operational environment to the target operational environment, and generating and distributing messages to gain sponsorship for and keep members of the business organization informed about the transition. Business content is developed, including customized tasks, forms, correspondence, file notes and organizational data to be loaded into the automated computer system for use in operating the business organization in the target operational environment utilizing samples and templates of the interactive implementation toolkit.

### BACKGROUND OF THE INVENTION

This invention relates to a system and method for supporting organizational change management.

Change management may be considered to be the requisite activities required for navigating a business organization to a target/desired operational environment. Typically, change management is accomplished by a change management team, including employees from a technology-specialist firm/organization that handles change management efforts, and members of the business organization. The change navigation team performs the navigation, or transition, to the desired operational environment by upgrading both technology used in the business organization, and by instructing employees of the business organization as to utilization of the new technology.

Conventional change navigation efforts do not adequately educate employees of the business organization, and prepare management of the organization, for the transition to the desired operational environment. As a result, change navigation efforts are reduced in effectiveness as the transition is not adequately supported from within the business organization, and employees are not properly trained to operate to the full capabilities of the target operational environment. Further, the transition of the technology and the workforce to the desired operational environment is typically a complex process, for which the business organization is not properly prepared, further diminishing support for the transition from within the organization, and the morale of the employees of the organization.

Additionally, conventional change navigation efforts implement the desired operational environment to hastily, without sufficient testing, and at a budget not expected by the business organization. Such actions result in the business organizations being at increased risk of the desired operational environment performing poorly, and in some circumstances failing to conform to government regulations under which the business organization must operate. Further, unexpected budget produces a final strain on the business organization due to unexpected costs encountered during the transition to the desired operational environment.

Because of the increasing complexity of the issues which may arise during navigation to the desired operational environment, there is a need for improved systems and methodology for more efficiently and effectively implementing change management activities, which solve at least some of the problems discussed above.

### BRIEF SUMMARY OF THE INVENTION

This invention relates to a change navigation methodology for transitioning a business organization from an existing operational environment to a target operational environment using an interactive implementation toolkit.

In one embodiment of the invention, a system is provided for transitioning a business organization from an existing operational environment to a target operational environment, where the target operational environment uses an automated computer system running business processing software employing an event-based methodology for carrying-out a business transaction process, and the automated computer system includes an event processor for handling events generated by the business processing software in accordance with a set of event rules. The automated computer system further includes a rules library maintaining the set of event rules for use by the event processor in handling generated events, where the system includes an interactive implementation toolkit which provides methodology and data structures for carrying-out the transition to the target operating environment, the data structures including templates for recording rules for handling events generated by the business processing software, and a system processor capable of automatically extracting the rules from the template, and populating the rules library with the extracted rules. In a further embodiment, the data structures of the interactive implementation toolkit may further include sample forms and correspondence, tasks, and file notes.

In accordance with another embodiment of the invention, a memory embodied on a computer readable media programmed for operating on a suitable processor, and method, are provided for managing the transition of a business organization from an existing operational environment to a target operational environment using an interactive implementation toolkit is provided, where the target operational environment uses an automated computer system running business processing software for carrying-out a business transaction process. The method includes defining the target operational environment within the business organization and a corresponding course of action required to transition the business organization from the existing operational environment to the target operational environment, and generating and distributing messages to gain sponsorship for, and to keep members of the business organization informed about the transition. The method further includes developing business content, including at least customized tasks, forms and correspondence, file notes and organizational data to be loaded into the automated computer system for use in operating the business organization in the target operational environment utilizing samples and templates of the interactive implementation toolkit and providing individuals impacted by the transition with the knowledge, skills and performance support tools for performing within the target operational environment. Further yet, the method includes transitioning the business organization to the target operational environment, where the interactive implementation toolkit includes sample forms and correspondence, and file notes, to facilitate the implementation of the target operational environment, and after implementation, for improving efficiency of the business transaction process, and integrated sample templates for recording information to be used in transforming the existing operational environment to the target operational environment. In a further embodiment, the business organization may be an insurance claims business organization, where the business process software is insurance claims processing software for handling the processing of insurance claims.

In accordance with additional embodiments of the invention, a method for instructing a member of a business organization implementing an automated computer system for processing business transactions in a target operational environment, and for managing the implementation of an automated computer system of a business organization using an interactive implementation toolkit by facilitating transformation of a knowledge workforce are provided.

### BRIEF DESCRIPTION OF SEVERAL VIEWS OF THE DRAWINGS

FIG. 1A is a block diagram illustrating an exemplary business organization operational environment, which may benefit from the Change Navigation Toolkit in accordance with an embodiment of the invention;

FIG. 1B is a block diagram of an event-based system architecture, which may benefit from the Change Navigation Toolkit in accordance with an embodiment of the invention.

FIG. 2A is a block diagram illustrating the Change Navigation Toolkit in accordance with an embodiment of the invention;

FIGS. 2B-2D are exemplary screenshots of the Change Navigation Toolkit illustrating potential progressions of a user through the Toolkit, in accordance with embodiments of the invention;

FIG. 3 is a flowchart illustrating methodology for carrying out change navigation management efforts in accordance with an embodiment of the invention;

FIGS. 4A-4C are flowcharts illustrating methodologies for carrying out the business process portion 204 in accordance with an embodiment of the invention;

FIGS. 5A-5D are flowcharts illustrating methodologies for carrying out the communications and sponsorship portion 206 in accordance with an embodiment of the invention;

FIGS. 6A-6F are flowcharts illustrating methodologies for carrying out the business content portion 208 in accordance with an embodiment of the invention;

FIGS. 7A-7D are flowcharts illustrating methodologies for carrying out the training portion 210 in accordance with an embodiment of the invention; and

FIGS. 8A-8D are flowcharts illustrating methodologies for carrying out the transition portion 212 in accordance with an embodiment of the invention.

### DETAILED DESCRIPTION OF THE INVENTION

This invention relates to a change navigation methodology for transitioning a business organization from an existing operational environment to a target operational environment using an interactive implementation toolkit.

In one embodiment of the invention, a system is provided for transitioning a business organization from an existing operational environment to a target operational environment, where the target operational environment uses an automated computer system running business processing software employing an event-based methodology for carrying-out a business transaction process, and the automated computer system includes an event processor for handling events generated by the business processing software in accordance with a set of event rules. The automated computer system further includes a rules library maintaining the set of event rules for use by the event processor in handling generated events, where the system includes an interactive implementation toolkit which provides methodology and data structures for carrying-out the transition to the target operating environment, the data structures including templates for recording rules for handling events generated by the business processing software, and a system processor capable of automatically extracting the rules from the template, and populating the rules library with the extracted rules. In a further embodiment, the data structures of the interactive implementation toolkit may further include sample forms and correspondence, tasks, and file notes.

In accordance with another embodiment of the invention, a memory embodied on a computer readable media is provided, and is programmed for use on a suitable processor for managing the transition of a business organization from an existing operational environment to a target operational environment utilizing an interactive implementation toolkit, where the target operational environment uses an automated computer system running business processing software for carrying-out a business transaction process. The memory includes a first memory portion programmed for allowing for the defining of the target operational environment within the business organization and a corresponding course of action required to transition the business organization from the existing operational environment to the target operational environment, and a second memory portion programmed for allowing for the generation and distribution of messages to gain sponsorship for, and to keep members of the business organization informed about the transition. The memory further includes a third memory portion programmed for allowing for the development of business content, including at least customized tasks, forms and correspondence, file notes and organizational data of the interactive implementation toolkit to be loaded into the automated computer system for use in operating the business organization in the target operational environment, and a fourth memory portion programmed for allowing for the providing of individuals impacted by the transition with the knowledge, skills and performance support tools for performing within the target operational environment. Additionally, the memory includes a fifth memory portion programmed for allowing for the transition of the business organization to the target operational environment, wherein the programming of the first, second, third, fourth and fifth memory portions are selectably provided to a user of the interactive implementation toolkit (i.e. may be selectable accessed by the user).

In accordance with yet another embodiment of the invention, a method for managing the transition of a business organization from an existing operational environment to a target operational environment using an interactive implementation toolkit is provided, where the target operational environment uses an automated computer system running business processing software for carrying-out a business transaction process. The method includes defining the target operational environment within the business organization and a corresponding course of action required to transition the business organization from the existing operational environment to the target operational environment, and generating and distributing messages to gain sponsorship for, and to keep members of the business organization informed about the transition. The method further includes developing business content, including at least customized tasks, forms and correspondence, file notes and organizational data to be loaded into the automated computer system for use in operating the business organization in the target operational environment utilizing samples and templates of the interactive implementation toolkit and providing individuals impacted by the transition with the knowledge, skills and performance support tools for performing within the target operational environment. Further yet, the method includes transitioning the business organization to the target operational environment, where the interactive implementation toolkit includes sample forms and correspondence, and file notes, to facilitate the implementation of the target operation environment, and after implementation, for improving efficiency of the business transaction process, and integrated sample templates for recording information to be used in transforming the existing operational environment to the target operational environment. In a further embodiment, the business organization may be an insurance claims business organization, where the business process software is insurance claims processing software for handling the processing of insurance claims.

In accordance with another further aspect of this embodiment, the business processing software utilizes an event processor architecture where an event occurring during the business process is handled by an event processor in accordance with a predetermined set of rules, and the developing business content includes populating at least one template with rules to be utilized by the event processor in handling a corresponding event. In accordance with a further aspect, the rules for event handling are maintained in a rules library, and the developing business content includes establishing a librarian to maintain the rules library. Further yet, the rules for event handling are maintained in a rules library for use by the business, and the transitioning of the insurance claims business organization to the target operational environment includes automatically populating the rules library with the rules from the template.

In accordance with another embodiment of the invention, a method for instructing a member of a business organization implementing an automated computer system for processing business transactions in a target operational environment, the members of the business organization using an interactive implementation navigation toolkit includes displaying a list of various steps in the implementation process on a display screen of a computer system, and allowing the user to randomly select one of the steps on the displayed list. The method further includes displaying a description of the step and at least one of a plurality of first graphical icons and first hyperlinked text, the at least first icon and hyperlinked text representing at least one of an additional step, and sub-step thereof for the selected step, and displaying at least one of a plurality of second graphical icons and second hyperlinked text, the at least second icons and hyperlinked text representing sample deliverables, including sample forms and correspondence, and file notes, to facilitate the implementation of the target operational environment, and after implementation, for improving efficiency of the business transaction process, and sample deliverables including integrated templates for recording information to be used in existing operational environment to the target operational environment. The method further includes that in response to the user selection of at least one of the first and second icons and hyperlinked text, the description of at least the step, sub-step, and sample deliverables corresponding to said respective icon or hyperlinked text is provided.

In accordance with yet another embodiment of the invention, a method of managing the implementation of an automated computer system of a business organization using an interactive implementation toolkit by facilitating transformation of a knowledge worker workforce includes defining a target operational environment of the business organization including target business processes for the business organization, workforce performance measurements at least one of during and after the transition, workforce skill enhancements for operating in, and job reclassification for, the target operational environment, and a management reporting, while accounting for capabilities of the automated computer system. The method further includes instructing management on techniques for encouraging employee commitment to transformation of the business organization, including instruction of creating and distributing messages for gaining sponsorship of the transformation and messages providing information regarding the transformation of the business organization to at least one of the workforce, sponsors and stakeholders of the business organization, and developing customized tasks, forms and correspondence, file notes, and organizational data for use in the automated computer system of the target operational environment for supporting the transformation of job responsibilities, and for providing at least one of any the workforce, sponsors and stakeholders of the business organization and personnel related to the business organization with knowledge, skills and performance tools for performing in the target operational environment. The method includes, further, creating a plan for transitioning the business organization and workforce to the target operational environment. In a further embodiment, the method may include transforming the business organization to the target operational environment.

This invention relates to a change navigation methodology for transitioning a business organization from an existing operational environment to a target operational environment using an interactive implementation toolkit. The interactive implementation toolkit (Change Navigation Toolkit) provides an efficient and effective methodology for transitioning the business organization by enabling teams responsible for the transition of the business organization (Change Navigation Teams) to more efficiently, effectively and confidently support technology implementations with proven methodology and tools, and provides change navigation best practices, tools and sample deliverables for the transition to the target operational environment and thereafter.

The Change Navigation Toolkit and methodology provided thereby may be beneficial to any business organization desiring a transition from their existing operational environment to a target (desired) operational environment, including but not limited to insurance organizations, financial institutions, government organizations/entities, manufacturing organizations/companies, and any service-based organizations. The Change Navigation Toolkit may be useful for transitioning the business organization through technology upgrades, including upgrading any computer system used in by the business organization, and/or any business processing software used by the business organization for carrying out a business transaction process. Further, or in the alternative, the Change Navigation Toolkit is beneficial in providing any individuals impacted by the transition to the target operational environment, including any employees of the business organization, and members of other organizations who interface with the business organization, with knowledge, skills, and performance support tools for performing both during and after the transition to the desired operational environment.

The change navigation methodology employed utilizing the Change Navigation Toolkit may include defining the target, or desired, operational environment within the business organization. Such definition of the target operational environment may include leveraging the capabilities of the technology implemented, an existing automated computer system operating within the existing operational environment, or in an updated/improved computer system of the desired operational environment, including any enhanced processes, performance measurements, skill enhancements, job redefinitions and management reporting provided therein. Further, the Change Navigation Toolkit may include methodology on coaching management regarding techniques for encouraging employees of the business organization to commit to, and be excited about, the transition. Such techniques may include instructing management on crafting and distributing key messages to gain the sponsorship of executive stakeholders (i.e. anyone affected by, or who has an interest in, the transition) within the business organization, and to keep members of the business organization informed about the transition.

The Change Navigation Toolkit may further include methodology providing for the development of, and actual samples of, customized tasks, forms and correspondence, file notes, and organizational data which may be utilized within the automated computer system of the desired operational environment for transformation of job responsibilities, thereby providing audiences impacted by the transformation with knowledge, skills and performance tools required to perform in the desired operational environment. Further, the Change Navigation Toolkit may provide methodology for creating a transition plan for transitioning the business organization and employees thereof to the desired operational environment.

The Change Navigational Toolkit provides such methodologies within an interactive software package, which may be provided on an optical memory (i.e. Compact Disk), or any other computer readable memory, and which may be run on a stand-alone personal computer or a personal computer connected with a computer network. Alternatively, the Change Navigation Toolkit may be provided via the Internet, as access to a particular Internet site having the methodologies and data structures (discussed below) employed thereby. The Change Navigation Toolkit allows users (i.e. change navigation teams carrying-out the transition of the business organization) to selectively navigate, using inter-linked portions of the Toolkit (discussed further below), through the provided methodologies and guidelines and/or considerations for transitioning the business organization. Such inter-linked portions allow users of the Change Navigational Toolkit to directly access the methodologies of the toolkit for which they are interested. Such linked portions may further provide access to data structures such as sample customized tasks, forms and correspondence, and file notes provided within the toolkit, or provide directions, guidelines and/or considerations in creating tasks, forms and correspondence, and file notes to be used during, and after the transition.

The above embodiments may include additional features consistent with the following detailed description that illustrates various aspects and details of the invention and its preferred implementation. This detailed description is intended to illustrate, but not to limit the invention. One of ordinary skill in the art may modify these embodiments in view of the following techniques and be within the intended scope of the invention. The following written description, which is directed mainly to transitioning an insurance claims organization to a target operational environment utilizing insurance claims processing software, may be readily adapted for use in any business industry/organization, based on the particular needs of the organization. Thus, this description may be applied to, and implemented in any business industry/organization using the teachings described herein.

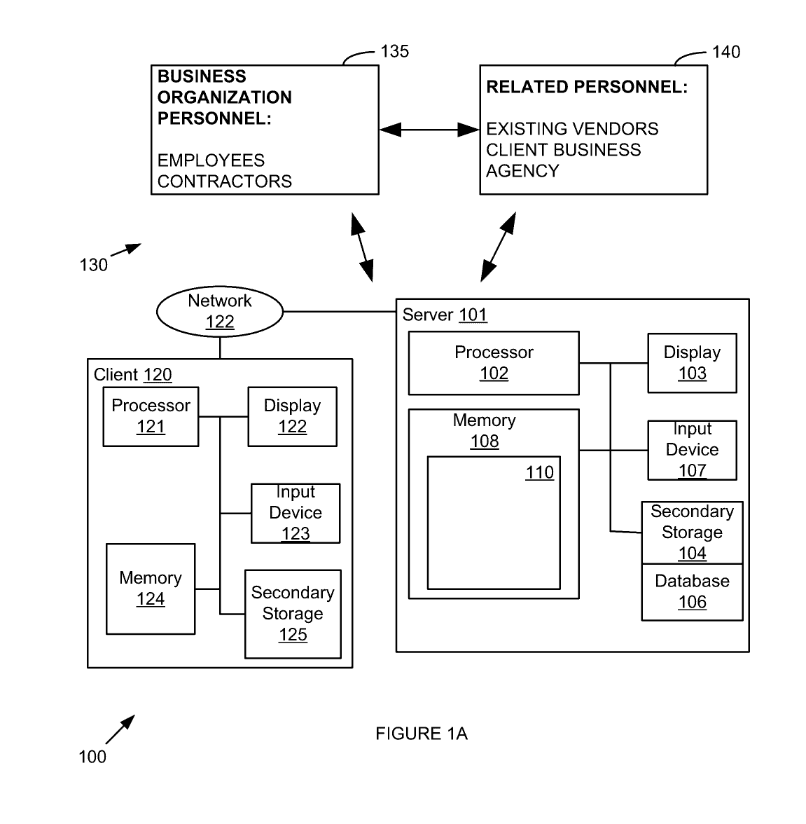

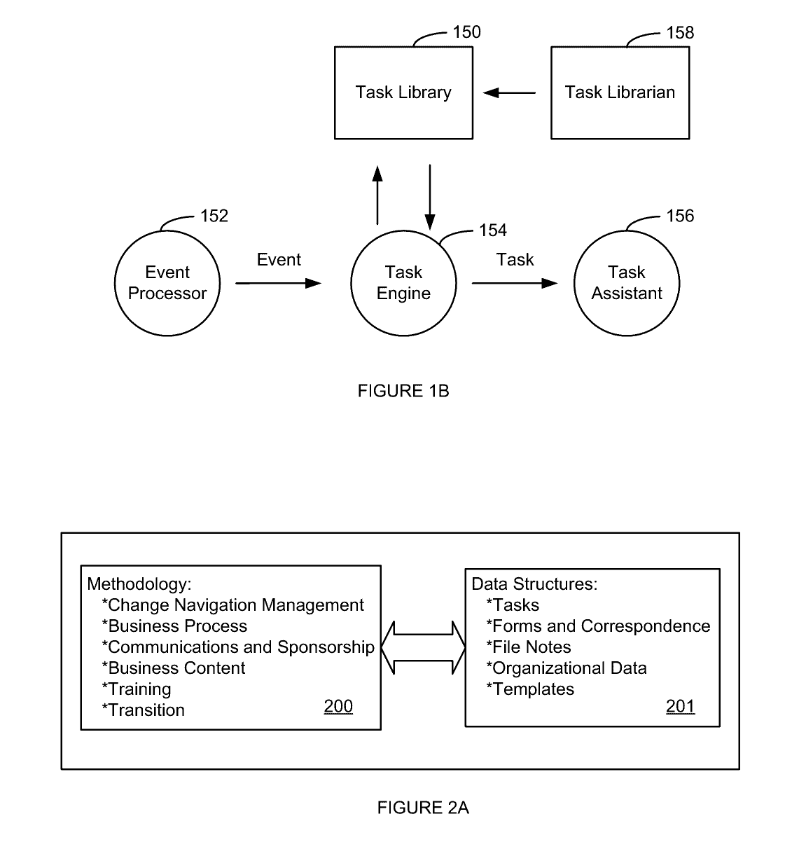

An exemplary business organization operational environment which may benefit from the Change Navigation Methodology described herein is illustrated in FIG. 1. Such an operational environment typically includes a technological aspect 100, and a personnel aspect 130. The technological aspect 100 typically encompasses technology utilized by the business organization in carrying out day-to-day business processes, while the personnel aspect 130 typically encompasses personnel, internal or external to the business organization, who are a part of carrying out business processes or affected by business processes of the business organization.

The technological aspect 100 typically includes a computer network 122 operating under the control of a server 101, and having one or more client computers 120. The network 122 provides communication between the one or more client computers 120 connected to the network 122, utilizing for example hardwire connections, Internet, business organization Intranet, wireless communication, or any other fashion for providing communication between the client computers 120 as would be appreciated by one skilled in the art. The server 101 may provide some control over communication between client computers 120 and provide processing capabilities as well as a common storage media for use by one or more client computers 120 of the network.

The server 101 typically includes a processor 102 for carrying out any computational or processing needs of the server 101, a display device 103 for displaying information to a user of the server 101, a secondary storage device 104 for providing supplemental memory/storage device for the server 101, which may include a database 106 for maintaining information for the business organization including, for example, information regarding products, services, transactions, or clients for the business organization. The server 101 may further include an input device 107 allowing for information entry at the server 101, and a memory 108 for use by the server in storing any programming, data or other information in carrying out processes at the server 101. For example, the memory 108 may include business processing software for the business organization, for example, in an insurance institution handling claims processing, such a program 110 may include software for processing insurance claims. The memory 108 may further encompass any volatile memory (i.e. random access memory) to be used by the server 101 in carrying out processes provided thereby.

Each client computer 120 may include a client processor 121 for handling processing needs at the client 120, client display device 122 for displaying information to a user of the client computer 120, a client input device 123 allowing for information to be entered at the client computer 120, a client memory 124 providing for temporary and long-term storage of information and programming at the client computer 120, including random access memory and non-volatile storage such as a hard drive, and a client secondary storage device 125 providing supplemental storage for the client 120. Although not shown, the technological aspect 100 may further include individual personal computers not in communication with the network 122, for use in conducting business for the organization. Such personal computers would be similar in structure to the client computers 120.

The personnel aspect 130 includes both business organization personnel 135, and any related personnel 140. The business organization personnel 135 includes employees of the business organization, and contractors currently working with the business organization. The related personnel 140 typically includes outside vendors and other client business organizations impacted by or participating in the business process carried out by the business organization.

The technological aspect 100 may be accessed by any business organization personnel 135 or related personnel 140 with sufficient security clearance. Such access is provided typically through the client computers 120, and is typically controlled through the server 101. Further, business organization personnel 135 typically communicate/interface with related personnel 140 during the standard course of business process carried out by the business organization, within the operational environment of the business organization.

When a business organization desires to change its operational environment from an existing operational environment to a target, or desired, operational environment, such a change typically encompasses upgrading portions of the technological aspect 100 of the operation environment. Such a technological aspect 100 upgrade may include one or both of upgrading business processing software for handling business transactions within the business organization, and the hardware necessary for carrying out the business transaction software. In either case, it is beneficial to prepare the business organization personnel 135 and any related personnel 140 for the change to the technological aspect 100.

For the purpose of this discussion, the change navigation methodology and Change Navigation Toolkit will be discussed in the context of transitioning an insurance business organization handling insurance claims from an existing operational environment using existing claims processing software to a desired operational environment operating using improved claims handling software. However, as discussed above, the change navigation methodology and Change Navigation Toolkit employed herein may be utilized in transitioning any business organization from the existing operational environment to the desired operational environment while realizing at least some of the benefits and advantages discussed herein. Further, the present discussion will be in the context of transitioning the existing operational environment of an insurance claims organization to a desired operational environment which employs a new claims technology system including new claims processing software, and the necessary computer hardware upgrades for utilization of the new claims processing software. However, as discussed above, Change Navigation methodologies employed herein need not be utilized in upgrading both business processing software and computer hardware, but may be employed in upgrading either the software or hardware of the technical aspect 100.

Thus, returning to FIG. 1, in an insurance business organization which handles claims processing, the business organization employees 135 may include, but are not limited to, field adjusters, adjusters by line of business, supervisors for regional offices of the business organization, administrative staff, litigation management department staff, and contact center department staff. Further included may be any staff of the recovery department for the claims organization, underwriting department, loss control department, workers' compensation units, immediate response unit, and special investigation units/fraud units personnel. The related personnel 140 typically include, but are not limited to, third party claims administrators, vendors, insurance agents, the insured individuals, and any insurance claimants.

The client computer(s) 120 are utilized by employees of the insurance claim processing organization in varying capacities depending on the particular employee's job position and responsibilities within the claims organization. The client computers 120 allow for internal communication between claims organization employees, the handling of insurance claim processing, including the drafting of any necessary correspondence to clients outside of the claims organization or to other persons internal to, or related with, the claims organization, and the entry of information regarding actual claims made to the claims organization. The client computers 120 also provide for the transfer of claim-related information to other business organization or related personnel where necessary to the handling of a particular insurance claim. The functionality of the client computer(s) 120 may be provided through software resident within the client computer memory 124 or client secondary storage 125, or via programming resident with the server 101.

The server 101 and network 122 provides a communication link between client computers 120 of the claims organization, and may include claims processing software for handling insurance claims processing, and claims organizational entity information describing the relationship and job responsibilities of employees within the claims organization and their relationship with the related personnel 140.

In one embodiment, shown in FIG. 1B, where an event-based processing architecture is employed by the business processing software, the database 106 of the secondary storage 104, or the memory 108, may further include a library of information 150 (i.e. rules for handling various events which may occur during operation of the business processing software) to be used by the claims processing software of the business organization in describing how the particular event is to be handled by the business processing software (i.e. send a corresponding business record to another employee of the business organization, generate a particular piece of correspondence, etc. . . . ).

Here, an event processor 152 is notified within the business software of an event which has occurred, and passes the event on to a task engine 154. The task engine 154, in accordance with rules maintained in the task library 150, determines (i.e. receives from the task library 150) one or more tasks to carry out in response to the event, and passes such tasks on to a task assistant 156 for carrying-out the tasks. In accordance with this embodiment, the Change Navigation Toolkit may provide a data structure as a template for use in recording the rules for event processing, or for recording any other information in configuring the business processing software for operating in the desired operational environment, as will be described further below. One or more task librarians may be established for maintaining the task library as is discussed below. In accordance with a further embodiment of the invention, the Change Navigation Toolkit may include functionality for automatically extracting recorded rules from templates of the Change Navigation Toolkit, and automatically populating the task library 150 with the rules for event-handling, as discussed further below.

The event-based architecture may be utilized on networks, stand-alone personal computers, or any other equipment having memory and processing capabilities. For example, with respect to the technical aspect 100 described in FIG. 1A, the operations performed by the event processor 152, the task engine 154 and the task assistant 156 may be carried out by the processor 102, the client processor 121, or by a processor on any stand-alone personal computer (not shown), where the task library may be stored in the memory 108, on secondary storage 104, on client memory 124 or client secondary storage 125, or on any other computer readable storage media accessible by the processor carrying out the event-based processing, as would be appreciated by one skilled in the art. Further information regarding event-based processing is described in the U.S. patent application, “Method And Article Of Manufacture For Component Based Task Handling During Claim Processing”, to Guyan et al., filed on May 4, 1999, and having U.S. Ser. No. 09/305,234, hereby incorporated by reference herein.

In accordance with another embodiment of the invention, the secondary storage 104 or memory 108 may further include other data structures such as tasks, pre-formatted file notes, pre-formatted forms, letters, memos, documents and other communication materials, or samples thereof, either provided by the Change Navigation Toolkit, or created in accordance with information/guidelines/considerations provided by the Change Navigation Toolkit as described further below.

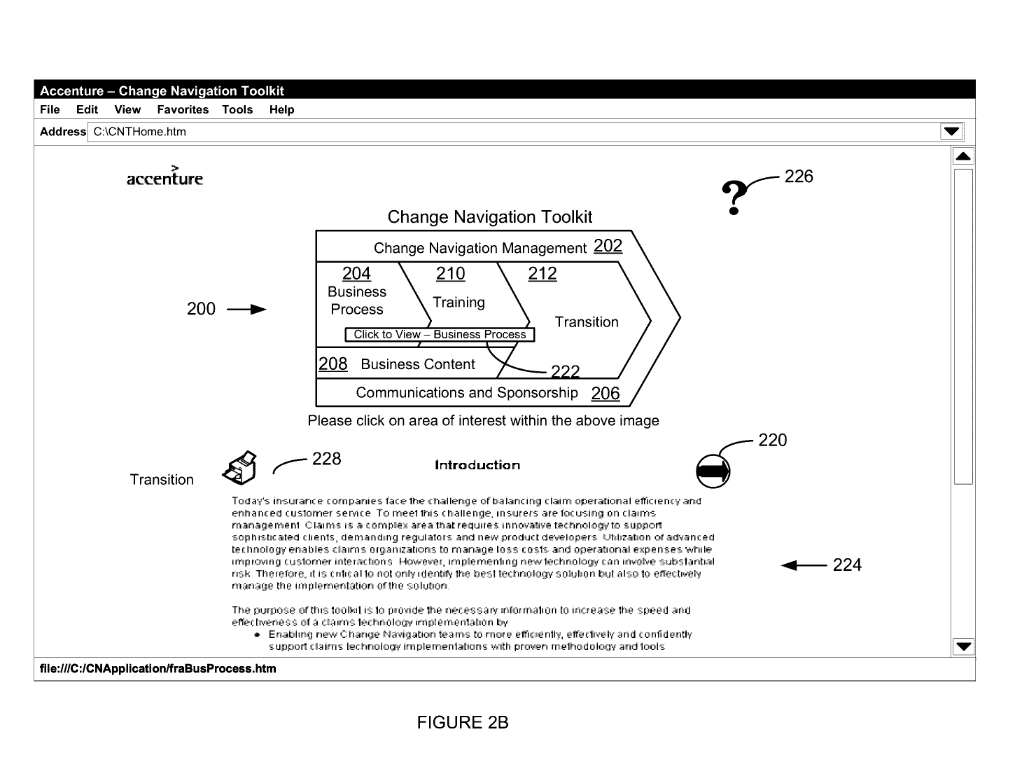

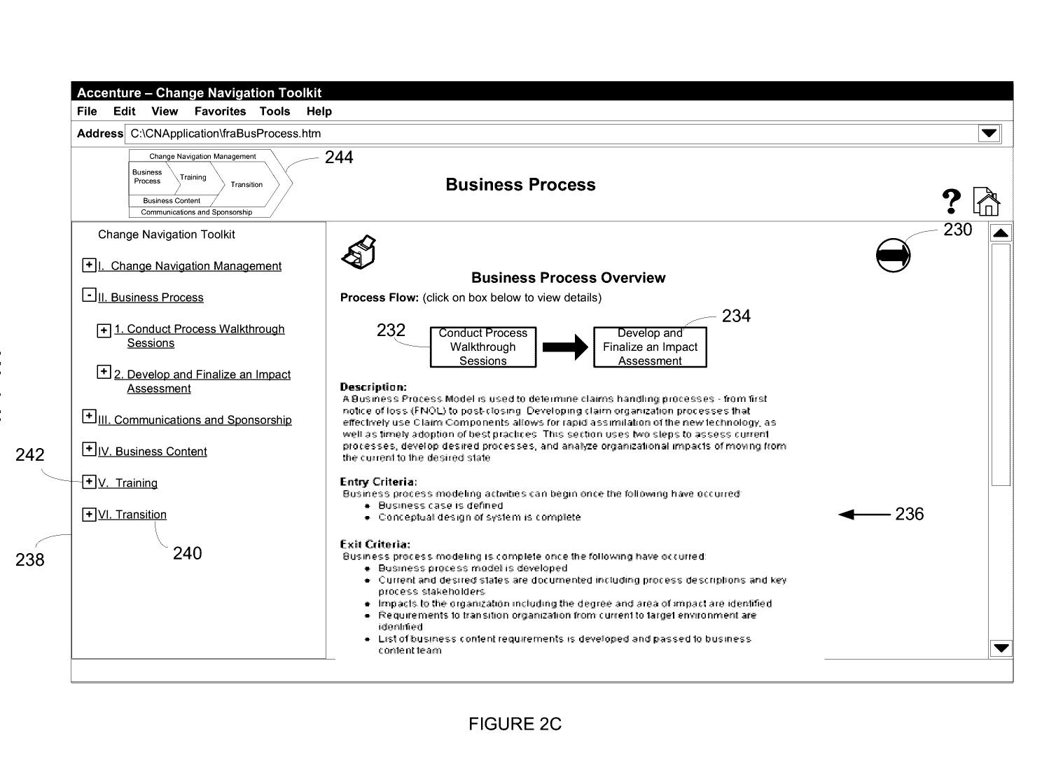

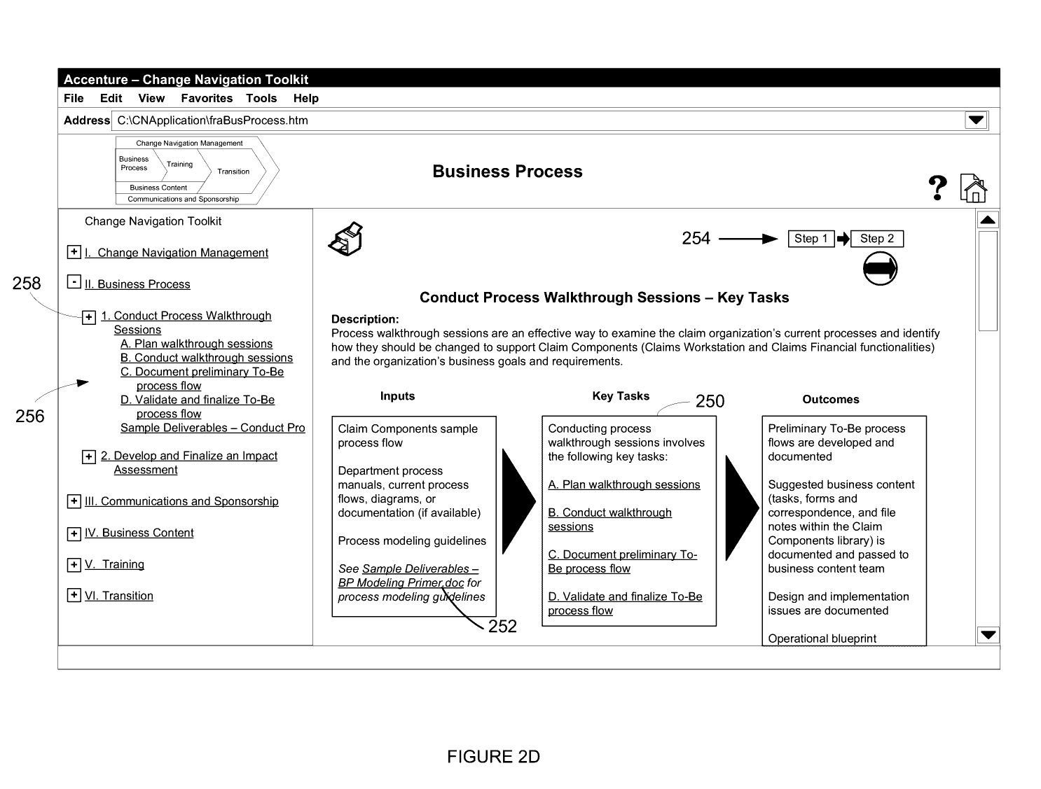

A block diagram of the Change Navigation Toolkit is shown in FIG. 2A. As shown in FIG. 2A, the Change Navigation Toolkit provides various methodology components, or portions 200, in a hierarchical structure, for use in carrying out a change navigation methodology in transitioning an insurance organization handling client claims from an existing operational environment to a desired operational environment. Further, the Change Navigation Toolkit provides data structures 201 including document deliverables (i.e. templates, reports, logs, forms and correspondence, tasks etc. . . . ) which may be provided as sample deliverables, or as actual documents for use during and after the transition. Additionally, or in the alternative, the Change Navigation Toolkit deliverables may be in the form of guidelines as to content for various templates, reports, logs, forms and correspondence, tasks, etc. . . . and considerations in drafting/using a respective document/sample deliverable, as discussed below. Providing the document deliverables and/or sample deliverables saves the change navigation team the time and effort which would be required if the team were to draft the respective documents for the transition from scratch.

The data structures may be stored on any computer readable medium, including computer cache or random access memory (i.e. memories 108 or 124 of FIG. 1A), and are preferably linked to the network 122 or other personal computer having the business processing software, for selectively downloading desired data structures to such a network/computer, including downloading rules into a rules library such as the task library 150. As discussed above, the Change Navigation Toolkit, methodology portions 200 and any data structures 201, may reside on the client computer 120 or the server 101, or may be distributed across the client 120 and server 101, with templates stored on either memory/storage media on the server 101, or on the client computer 120 for shared access across a variety of client computers 120.

The methodology portions 200 are shown in more detail in the screen shot of FIG. 2B, which is an exemplary screen shot from of the Change Navigation Toolkit, in accordance with an embodiment of the invention. As shown in FIG. 2B, the change navigation tool kit methodology portions 200 include a Change Navigation Management portion 202, a Business Process portion 204, Communications and Sponsorship portion 206, a Business Content portion 208, Training portion 210 and a Transition portion 212.

As further shown by the screen shot in FIG. 2B, graphical icons are provided to a user of the Change Navigation Toolkit, for example the graphical icons corresponding to each of the Change Navigation Management portion 202, a Business Process portion 204, Communications and Sponsorship portion 206, a Business Content portion 208, Training portion 210 and a Transition portion 212 discussed above, and, for example, an arrow icon 220. The graphical icons corresponding to the various methodology portions 202-212 allow the user to selectively proceed to any methodology and data structures corresponding to each of those methodology portions by selecting the respective icon using, for example a pointing device such as a mouse. The arrow icon 220 allows the user to select the next screen of information/methodologies/data structures provided by the Change Navigation Toolkit.

Further shown in FIG. 2B is an information box 222 which may be used to convey information to the user regarding instruction in proceeding in the Change Navigation Toolkit, or describing functionality of a particular graphical icon. For example, as shown by the information box 222 corresponding to the graphical icon for the Business Process portion 204, information is conveyed to the user that selecting that icon will progress the Change Navigation Toolkit to the Business Process portion 204 of the Change Navigation Toolkit. Further shown in FIG. 2B is a text portion, here a Change Navigation Toolkit introduction text portion generally indicated at 224 which provides the user with text information regarding, for example, a particular portion of the Change Navigation Toolkit being accessed. Further shown in FIG. 2B are a help icon 226 for accessing information in the use of the Toolkit, and a printer icon 228 allowing the user to print the page, or portion, of the Change Navigation Toolkit being accessed. Various sections of the Toolkit may utilize the print icon 228 in allowing the user to print data structures 201 (FIG. 2A) provided by the Toolkit as well.

Where the user selects the graphical icon for the Business Process Portion 204, the Change Navigation Toolkit proceeds to the Business Process portion 204 of the Toolkit, including any methodologies 204, and corresponding data structures and graphical icons and text. The screen shot of FIG. 2C illustrates the screen which appears to the user when the Business Process Portion 204 is selected.

As shown in FIG. 2C, further graphical icons such as the arrow icon 230, or box icons 232 and 234, as well as text such as the text generally indicated at 236, may appear. The box icons here describe some methodology for the Business Process portion 204, as well as provide the user with a means of directly, selectably, accessing such methodology and corresponding sub-steps for carrying-out the methodology and related text and data structures. Alternatively, the user may utilize the arrow icon 230 to access the next screen of the Change Navigation Toolkit. Further shown in FIG. 2C is a Change Navigator Menu bar 238, illustrating to the user where in the Toolkit they are presently located, and further provided the user with capabilities of accessing other portions/sections of the Toolkit via links, for example a link 240, and sub-links (not shown) accessed through link expansion boxes, for example a link expansion box 242. A further graphical icon is shown in FIG. 2C, a Toolkit icon 244, allowing the user to select the various portions of the Change Navigation Toolkit similar as described above with reference to FIG. 2B. Upon selection of the box icon 232, a screenshot as shown in FIG. 2D may appear.

As shown in FIG. 2D, information regarding the methodology for the particular box icon is displayed, as well as graphical icons and corresponding data structures. For example, further methodology/steps 250 are displayed as well as information necessary for completing the additional steps, and results/Outcomes after completion of the steps. Data structures are further provided, for example, here the sample deliverable 252 providing to the user a Business Process primer document. The user needs just to simply select the data structure, here sample deliverable 252, by selecting its corresponding link, and the deliverable is provided to the user on the screen, and may be read, saved for later modification, and/or printed by the user. Further shown in FIG. 2D are step-box icons shown generally at 254 indicating where the user is in the particular Toolkit portion being accessed, and providing to the user a means of selectably accessing other steps in the particular methodology using, for example, a mouse. Further yet, the sub-steps are illustrated to the user at 256 through expansion of the expansion box 258, further illustrating to the user where the user is in the particular Toolkit portion being accessed, and providing to the user another means of selectably accessing other steps in the particular methodology using, for example, the mouse.

The method of transitioning a business organization, here an insurance claims organization, from an existing operational environment to a target operational environment utilizing the Change Navigation Toolkit will now be discussed. In transitioning an insurance claims organization from an existing operational environment to a desired operational environment, it may first be desirable to plan for the management of the transition. The Change Navigation Management Portion 202 of the Change Navigation us useful in accomplishing this.

### Change Navigation Management Portion

Change Navigation Management portion 202 allows for leading change navigation efforts throughout the new claims technology system implementation, from recruiting and educating Change Navigation Team members to managing development efforts and monitoring transition success for the business organization. Change navigation allows for managing the transition of the claims organization from its existing operational environment to a desired, target operational environment. A goal of a Change Navigation Team is to minimize the impact to the business organization and to mitigate the risks associated with a transformation to the desired operational environment, typically operating under a new claims technology system.

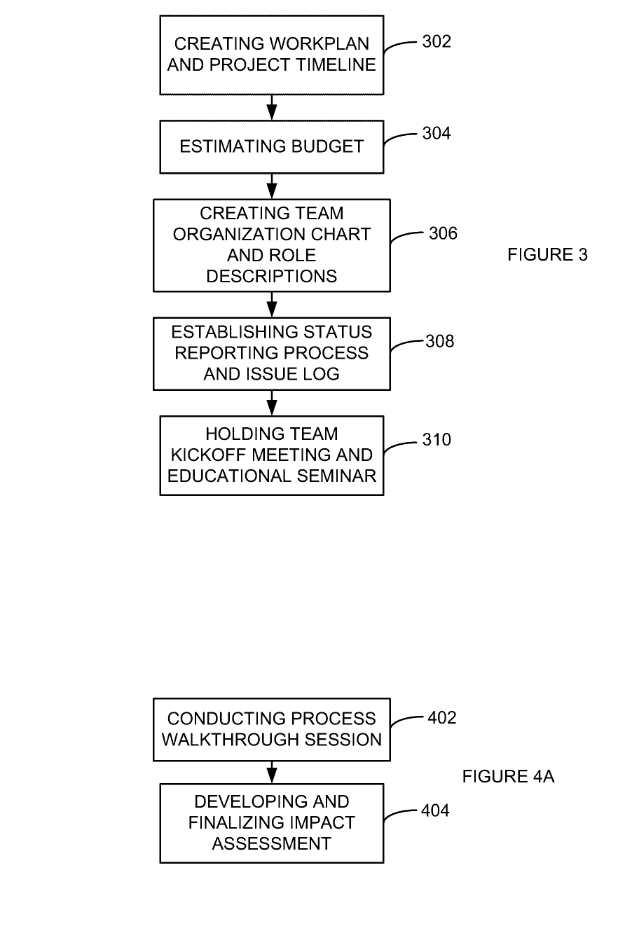

The Change Navigation Management may be accomplished using five components/portions of change navigation efforts, further discussed below, including Business Process Portion 204, Communications and Sponsorship Portion 206, Business Content Portion 208, Training Portion 210 and Transition Portion 212. The methodology for carrying out Change Navigation Management may be accomplished as set forth in FIG. 3.

FIG. 3 illustrates a flow chart representing methodology which may be employed in managing change navigation within a business organization, in accordance with an embodiment of the invention. To manage change navigation efforts, a work plan and project timeline are created as shown at step 302, a budget is estimated for the new claims technology system implementation (i.e. technological aspect 100 of FIG. 1) at step 304, team organization charts and role descriptions are created, step 306, a status reporting process and issue log are established at step 308, and a team kickoff meeting and educational seminar is held as shown at step 310.

Creating the work plan and project timeline of step 302 may include consideration as to business process software operating under the target operational environment. The business process software for the technological upgrade discussed herein will be a Claim Components software as provided by the Claims Solution Group of accenture. However, as would be appreciated by one skilled in the art, the methodologies provided by the Change Navigation Toolkit as well as any sample tasks, file notes, and forms and correspondence, would be applicable in transitioning to other business processing software and the necessary hardware in supporting such a transition.

A Claim Components implementation (transition to a desired operational environment employing Claim Components) utilizes six key phases with various corresponding change navigation activities, which must be planned and executed within each phase. One or more of the six key phases may also be applicable to implementing any other technology aspect including any other business processing software, as well. The key project phases include conceptual design, detailed design, construction, assembly testing, and product testing of the desired operational environment, and pilot and transition to the desired operational environment. The work plan is a tool that outlines these activities/deliverables by project phase, the corresponding start and end dates for the activities, and the person(s) (or Change Navigation Team) responsible for completing each task.

The project timeline is utilized to pictorially depict the major milestones and activities of the change navigation effort in transitioning to the desired operational environment, where the work plan is utilized as an input to the project timeline. The Change Navigation Toolkit employed for the transformation may be used to communicate Change Navigation Team status and scope with other Change Navigation Teams and with project management. As will be described further below, the Change Navigation Teams typically comprise personnel from both the business organization being transitioned, and from a technology-specializing firm/corporation, for example, Accenture.

The Change Navigation Toolkit may provide a sample workplan and project timeline, thereby illustrating the format for such documents while listing the items to be considered in each. Such a sample workplan and project timeline is beneficial in giving the Change Navigation Teams at least start-off points for generating such documents.

The budget estimation of step 304 may be accomplished, based upon change navigation project management guidance, to create an estimated (non-payroll/non-consulting fee) change navigation budget. The budget is typically organized and tracked by each change navigation sub-team (i.e. change navigation teams responsible for the change navigation transition, further discussed below.) The budget accounts for various activities and items including considerations to communications (i.e. regarding sponsorship meetings and travel, motivational items, communication vehicle setup and maintenance), business content (working session costs), training (including Accenture packaged training, vendor development/modification costs, printing and distribution, training preparation activities, training facilities, and trainer travel including airfare, hotel, per diems, etc.), and transition (including new equipment such as hardware/software, equipment installation travel, equipment contractor fees, control room facilities, field support preparation, transition guide printing and distribution, transition support travel such as airfare, hotel, per diems, etc., management preparation sessions, and follow-up activities including those activities which require travel).

The team organization chart and role descriptions may then be created as shown at step 306. The Change Navigation Team is typically organized into five sub-teams to support the five components/phases of change navigation efforts, including a Business Process team, Communications team, Business Content team, Training team and a Transition team. Each sub-team may include a team leader(s) and supporting analyst/developer positions, where the number of analysts/developer positions within each sub-team is dependent upon the scope of the change navigation efforts. As discussed above, the change navigation sub-teams are typically comprised of employees from both the business organization being transitioned, and personnel of the technological specialist firm/organization. However, such teams may be comprised entirely of personnel of the business organization, or of personnel of the technology-specializing firm/corporation while still employing the methodologies described herein. The Change Navigation Toolkit may provide a sample deliverable, team organization chart which lists various roles to be carried out by each of the Change Navigation sub-teams.

A status reporting process and issue log are established as shown in step 308. Throughout the life of the project, frequent status updates and escalation of issues from each sub-team will be important to effectively manage efforts and provide overall change navigation status to project management. To facilitate status reporting and issue log generation, various mechanisms are typically established and utilized including status meetings, status reports, team action record (TAR), and issue logs.

The status meetings may include a team leader meeting held on, for example, a weekly or bi-monthly basis between all change navigation sub-team leaders and management to discuss cross-team issues (i.e. issues affecting more than one change navigation sub-team), disseminate information to the sub-teams and management, and to discuss upcoming activities. An all-hands meeting may be held, for example, bi-monthly, with all Change Navigation Team members to promote cross-team knowledge sharing and team building, to disseminate team-wide information, and to provide a forum for questions. One-on-one meetings between each sub-team leader(s) and management may be held, for example, on a weekly basis, to discuss sub-team specific status, issues and management support needs.

Status reports may be utilized on, for example, a weekly basis, to allow each sub-team to provide management with key accomplishments, next steps and issues according to work plan milestones. A template status report is typically created and distributed to all sub-team leaders. The team action record includes a list of project team follow-ups or to-dos. The team action record includes a description of the required action, the date assigned, the date due, the owner of the action, and the resolution or associated comments. The issue log provides a central depository for the collection and management of escalated issues and their corresponding resolution. The Change Navigation Toolkit may provide at least one of a sample template status report, sample team action record, and sample issue log which may be utilized by the change navigation team(s) in determining proper format for the respective documents as well as the information contained therein.

Team kick-off meetings and educational seminars may be held, as shown in step 310. The team kick-off meeting provides a forum for all new team members to meet and build relationships, to receive motivational and team building messages, and to gain knowledge regarding the scope and vision for future change navigation efforts. Team kick-off meetings are recommended in conjunction with a change navigation seminar to educate team members on how to execute change navigation activities specific to their sub-team. The Change Navigation Toolkit may provide a sample change navigation educational seminar course summary for use in planning or holding the change navigation seminar.

### Business Process Portion

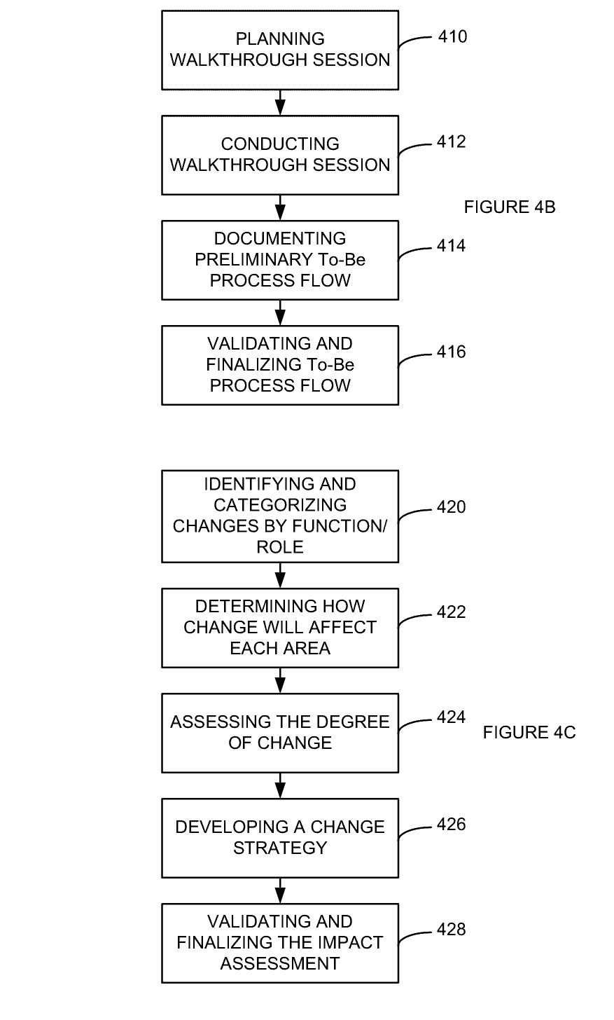

The Business Process portion 204 is used in determining a current business process for the business organization, here current claims handling processes, from first notice of loss (FNOL) to post-closing of the claim. Developing claim organization processes that effectively leverage Claim Components software allows for rapid assimilation of the new technology, as well as timely adoption of best practices. Methodology for implementing the Business Process portion 204 is shown in the flow chart of FIG. 4A.

FIG. 4A illustrates methodology for implementing the Business Process portion 204 in accordance with an embodiment of the invention. To implement Business Process portion 204, the current processes for the organization are assessed, and a target/desired process is developed for the business organization by conducting a process walkthrough, as shown at step 402. Next, the organizational impacts of moving the organization from the current to the desired state is analyzed by developing and finalizing an impact assessment as shown by step 404.

The planning and conducting a business process walk-through session of step 402 utilizes the process flow for the business process software to be implemented, here, the Claim Components sample process flow, business organization department process manuals, current process flows, diagrams, or documentation (where available) and process modeling guidelines in planning and conducting the business process walk-through session. The Change Navigation Toolkit may include a sample business process modeling primer which provides guidelines and considerations to the change navigation teams for process modeling.

The planning and conducting a business process walk-through session of step 402 is further detailed by the flowchart of FIG. 4B. As shown by FIG. 4B, the walk-through session is planned at step 410, the walk-through conducted at step 412, where To-Be process flows are preliminarily documented at step 414, and the To-Be process flows are validated and finalized as shown at step 416.

The walk-through session is planned at step 410 by establishing team roles, identifying session participants, and creating an agenda for the process walk-through. A business process team with detailed knowledge of the business process software to be utilized in the desired operational environment, here Claim Components, typically conducts the walk-through session. Some roles of the Business Process team include a business process team leader, and business process analysts. The business process team leader typically manages the claims business process finalizing effort, facilitates working and validation sessions, manages process approach and timeline, and evaluates the performance of the team members. The business process analysts typically participate and assist facilitation of working and validation sessions, and document processes and issues from the working sessions.

In addition to the business process team, it is desirable to have key process stakeholders participate in the session. Such stakeholders may include claim process subject matter experts, claims process performers/adjusters, claims process supervisors, claim managers, personnel from field offices, personnel from home office functions (including immediate response unit, recovery unit, litigation, medical management, salvage, investigation, etc.), support staff, or any other personnel/individuals affected by the transformation. Such participants may vary depending on the claims process being addressed in the walk-through session.

The business process team typically develops a standard agenda to be used for conducting the process walk-through sessions. The standard agenda may include reviewing the business processing software capabilities, here the Claim Components capabilities, discussing session guidelines, reviewing and examining current claims processes, identifying modifications for Claim Components and/or best practices documenting To-Be process flows identifying impacts to claims organization and documenting any content development requirements. Such an agenda is useful as it maps the current business processes carried out by the business organization to the business process software to be employed in the desired operational environment (i.e. Claim Components). The Change Navigation Toolkit may provide a sample deliverable Business Process To-Be outline, setting forth business processes which may be reviewed for a particular business organization.

The standard process flows which are usually reviewed in the walk-through session in an insurance organization are claim reporting (first notice of loss), claim assignment, policy validation, claim investigation evaluation and negotiation, salvage, recovery evaluation, recovery resolution, claim closing, claim re-opening and fraud handling. Claims Components supports the standard process flows as follows. Regarding claim reporting, purge/archive/destroy claim processes are supported, and a claim tracking process typically supports the claim assignment process. Policy validation is supported by a payments process, and claim investigation evaluation and negotiation is supported by a print process. The salvage process is supported by medical management processes, and a recovery evaluation process is supported by litigation management processes. Claim closing may be supported by a disability management process and claim re-opening supported by a claim handling inquiry process, and fraud handling supported by a controverted claim supporting process.

After identifying the working session participants, a foundation of knowledge concerning the business processing software to be implemented, here Claim Components, is usually provided to the participants. Such knowledge allows processes to be modified according to full utilization of the Claim Components capabilities and aid participants in understanding how the claim organization can be transformed as a result of revised processes.

In educating the working session participants, Claim Components system capabilities including Claim Folder, Task Assistant, Claim Assignment, Name Address Book, Participant, Event, Processor, Find Claim, Claim History, and Negotiation may be taught.

The Claim Folder capability provides a desktop environment which has an information repository, calculators, pre-formatted final notes, tasks, forms and correspondence. The Task Assistant provides an event processor that manages action items required to complete pending claims, that is, “tells the adjuster what to do and when to do it for pending claims.” The Claims Assignment allows a single claim to be assigned to multiple adjusters and allows a large number of claims to be assigned to different adjusters. The Name and Address Book provides a common definition for people and organizations external to the claims organization.

The Participant capability relates records in the Name and Address Book to claims, while capturing role-specific information. The Event Processor responds to claim events, and determines appropriate responses and ensures that they occur. The Find Claim is an index component which provides multiple search mechanisms for locating electronic claims. The Claim History records items which illustrate action items performed on a claim. The Negotiation records information regarding negotiation strategies, and expected outcomes and performers.

In addition, the conceptual design team may have additional suggestions and access to a Claim Components version of software to share with participants.

After an agenda has been defined and the participants for the walk-through session have been identified, at step 410 the walk-through session is carried out as shown at step 412. A goal of the walk-through session is to define impacts of the business processing software to be implemented (i.e. Claim Components) to the claim operations of the organization. In order to identify the impacts of Claim Components on the organization, the walk-through team discusses when, why, how and by whom the current processes are executed, identifies how the processes will change as a result of utilization of Claim Components and other best practices (To-Be process flows), and define the actions required to transform the current processes into To-Be processes. Further, key activities included in the process are reviewed, including determining who performs each activity and the timing and duration of each activity. System interfaces are denoted and documented and assumptions are made where there is incomplete information for the walk-through team. Role and responsibility changes are identified, and required or suggested business content is identified for the Claim Components library.

Other considerations may be utilized in guiding the walk-through sessions as provided by the Change Navigation Toolkit, including the fact that there is no pre-determined level of detail which should be captured by the new process flows, rather the level of detail will ultimately depend on the scale and scope of identified changes, which in turn, is highly dependent on the initial state to the organization as well as the scope and timing of the Claims Components implementation. Another consideration is that the process models are typically built in iterations, developing more detail with each iterative step, where usually three iterations are recommended for each process. Another consideration is that To-Be flows should include all processes that the organization will use in the target state, including current flows that are unchanged and/or new flows that did not previously exist, and claims handling best practices should be identified and included where appropriate. Yet, another consideration is that the team should distinguish the difference between core processes (high frequency or high importance) and non-core (low frequency or low importance) and focus initial design efforts on the core processes. A further consideration is that To-Be modeling should be approached from two perspectives, a business perspective and a system perspective, in order to highlight both business activities and corresponding Claim Components interaction.

The Change Navigation Toolkit may provide a sample business process modeling primer and business process modeling presentation encompassing the considerations discussed above, as well as providing further detailed information regarding process modeling and design.

The walk-through session is considered complete when all processes have been examined and changed to incorporate the business processing software, here Claim Component, functionality and capabilities.

Once the walk-through session of step 412 is conducted, and the changes to the current processes have been outlined, the preliminary To-Be process model should be documented as shown at step 414, allowing the results of the walk-through sessions to be captured. In addition, an issue log is typically started which is used to capture design and implementation issues and their resolution. The sample business process modeling primer and business process modeling presentation discussed above may be utilized here, as well as a sample business process To-Be claim assignment document provided within the Claim Navigation Toolkit which provides an example of a documented claim process may be utilized in generating the To-Be process model and issue log.

After the preliminary To-Be processes have been developed and documented, user populations are selected to validate the To-Be processes as shown at step 416, to ensure completeness, accuracy, and feasibility. Working sessions are utilized to facilitate the validation process. Each working session typically is conducted using a standard agenda, facilitated by one or two members of the design team. Working session participants usually include the process walk-through session participants, representatives from the content team, representatives from the Change Navigation Team and selected members of the technology development team.

Topics addressed during the working session usually include whether the processes meet the business requirement to the business case objectives, whether Claim Components is capable of supporting the process, whether the process is complete and accurate, and whether the current performance measurement systems align with the process goals, or whether the existing system should be modified. Further topics include identifying the critical dependencies or contingencies of the process, which resources are being optimized, whether the appropriate technology components in place support the process, whether there are facility and/or layout considerations to be addressed, if the process is supported by current policies and procedures or new ones need to be developed, and whether current roles and relationships are sufficient to perform the process, or will new role definitions be required.

The results of the validation sessions are typically documented in an operational blueprint which communicates the high-level impacts resulting from implementation of the new technology. Typically, working session participants consult with the transition team to determine any potential equipment impacts resulting from the To-Be processes. The Change Navigation Toolkit may provide a sample operational blueprint and/or operational blueprint template for use in generating the operational blueprint. Further, the Change Navigation Toolkit may provide a business process validation agenda for use in guiding the validation session.

Based on the results of the validation sessions, additions, deletions or modifications are typically made to the To-Be processes. Once the To-Be processes have been validated and appropriately modified, they are usually packaged in a user-friendly format for future use. The validated processes and operational blueprint is usually presented to senior management for approval. The completed package should be distributed to all relevant parties including the development team, key process stakeholders, and Change Navigation Team participants.

Returning to FIG. 4A, once the walk-through sessions are conducted at step 402, the impact assessment is developed and finalized as shown at step 404. The development and finalization of the impact assessment is further detailed in the flowchart of FIG. 4C.

Referring to FIG. 4C, in order to develop and finalize the impact assessment, the changes are identified and categorized by function/role at step 420, it is determined how the change will affect each area of the organization at step 422, the degree of change is assessed at step 424, a change strategy is developed at step 426 and the impact assessment is validated and finalized at step 428.

In order to identify and categorize the changes by function/role at step 420, the changes are typically identified on two levels including the function or roles, that is the process and stakeholder changes, and by department or area, that is the organizational changes. The functions and departments to be reviewed for the two levels in an insurance claims organization may include the field adjusters, adjusters by line of business, regional supervisors, administrative staff, litigation management department, contact center department, recovery department, underwriting department, loss control department, workers compensation unit, immediate response unit, special investigations unit/fraud unit, third-party administrators, vendors, agents, insured and the claimants.

By identifying the changes by function or role, the analysis is a detailed assessment which provides a foundation for training development purposes. In order to identify and categorize the changes, activities such as creating a list of claims, departments or areas affected by change, identifying roles within each department/function, and a walk-through To-Be process and system and list changes by process step or system functionality are usually performed.

The functions and roles which are typically impacted by the implementation include the claims administrative staff, claims professionals, claims management, the call center staff, recovery, the special investigation unit (SIU) and the employees' support group (help desk, etc.).

The analysis is usually completed using a standard template of the Change Navigation Toolkit so that information is captured consistently and at the appropriate level of detail. Function and role impacts can be identified in a number of different areas. To identify the impacts, the team should consider the process, job design, technology, organizational structure and resources, the culture and the management reporting.

The process includes assessing the policy and procedure differences between the current and the To-Be process flows, and the job design includes assessing the job requirement differences between the current and To-Be process flows. The technology includes assessing new hardware, software, network, skill-set and data requirements of the new processes and the organizational structure and resources include interviewing claims subject matter experts regarding optimizing organizational structure via office rationalization/consolidation. The culture includes assessing cultural impacts by using various methods such as surveys, focus groups and/or interviews, and the management reporting includes determining if there are implications for the way in which management will receive information.

After identifying and categorizing changes by function or role, it is determined how the change will affect each area as shown at step 422. Thus, the specific areas of the organization that are affected by each change are identified, and it is determined how the changes will affect each area. This allows the details of the changes to be summarized so that the managers will understand what will change in their department/function.

After identifying the impacts, the team typically categorizes the impacts by business area, where a table is generated showing potential impacts for each department/function. Such categories in the table may include the process, job design, technology, organizational structure and resource, culture, and management reporting areas, and their corresponding definitions.

After determining how the change will affect each area, the degree of change is assessed in order to facilitate the development of the change strategy, as shown at step 424. A standard scaling system, for example, provided by the interactive implementation toolkit, may be used such as rating the degree of change as high importance high risk, medium importance medium risk or low importance low risk. A high importance high risk rating may indicate that the impacts potentially cause the change to be ineffectively managed and increase the likelihood the business case objectives will not be achieved or that the user will reject the system, where a medium importance medium risk rating may indicate that the impacts potentially elongate timing and cost of the implementation. The low importance low risk rating may indicate that the impacts may cause user dissatisfaction.

To rate the degree of impact, various criteria are considered including the changes to current processes or to current roles and responsibilities, the changes in workload or in time to complete activities, the length of impact/time involved, the level of interaction with the customer (branch, region, etc.), and the amount of training/communication required for the change. Further criteria include the changes to current compensation/benefit packages, the number of employees which are impacted in the organization, and the difficulty of implementing the changes.

Based on the determined degree of impact for each change, a prioritized list of changes may be developed to determine which changes should receive the most attention and investment. Impacts with a high degree of impact should receive immediate attention and the most investment. Impacts with a medium degree of impact should receive moderate attention and investment, however, without being given a sense of urgency. Impacts with a low degree of impact are typically not a pressing concern and should receive minimal attention and investment.

After assessing the degree of change at step 424, a change strategy is developed to identify the method in which the changes will be addressed as shown at step 426. Guidelines for providing a framework for developing a change strategy include identifying the area of change and determining key methods to address the impact of the change. For the process area, key methods to address the impact may include developing processes or procedures and incorporating the processes into the training and online help and conducting process walk-through sessions with key users. For the job design area, key processes may include updating job descriptions, developing jobs specific training, changing performance measures, and hiring and/or staffing new resources. For the technology area, key tasks may include training users on the new technology, where in the organizational structure and resource area, the key tasks may include communicating to senior management, the organization, and updating job descriptions and performance measures. In the culture area, the key tasks may include redefining and articulating new claims visions, ensuring that the people of the organization understand why change is necessary and their particular role in the process, ensuring that management demonstrates support for the claim implementation, aligning the processes, organization, and information technology aspects with culture aspirations, and setting new norms of managing behavior and performance.

In the claimant area, key tasks for addressing impact may include developing communication plans for claimants, evaluating service levels across contact points, and posting information and updates to a web site dedicated to the chance. In the insured area, key tasks may include developing communication plans for the insured, evaluating service levels across contact points, and posting information and updates to the provided web site. In the agency area, key tasks for addressing the impact include developing communication plans for the agents, developing new processes or procedures, altering the training programs, changing performance management or incentive structures for the agents, and developing targeted online help for the agent. In the management reporting area, key tasks may include developing communication plan for management, aligning supporting processes, organization, and information technology aspects with developed reporting plan and designing training on information management.

The Change Navigation Toolkit may include a sample deliverable as a business process impact assessment and/or an impact assessment template for use by the business process team in determining or defining impacts of the transition to the business organization.

Once the change strategy is developed at step 426, it needs to be validated by the training and communication teams in order to validate and finalize the impact assessment as shown at step 428. Working sessions should be conducted to facilitate the validation process, where each working session should have a standard agenda and be facilitated by one or two members of the process design team. Feedback from the working session should be incorporated into the change strategy. Working session participants may include process walk-through session participants, a representative from the content team, representatives from the Change Navigation Team, and select members of the technology development team.

After the change strategy has been validated, and the feedback has been incorporated, the impact assessment document is finalized, and may be presented to management for approval. Upon approval of the final document, the impact assessment should be distributed to all relevant parties including the process design, training and communication teams.

### Communication and Sponsorship Portion

Communications and sponsorship portion 206 provides timely and effective communications to all stakeholders and sponsors for the transition to enhance user acceptability and maximize the benefits of the software utilized in the desired operational environment, here Claim Components. Further, communication and sponsorship activities create positive perceptions about, and motivate and excite employees about, the change which is about to occur within the organization. Communication and sponsorship activities may begin when project goals and expectations are defined. Communication and sponsorship activities are considered complete when all offices and units have been transitioned to the new technology, processes and practices, and when employees are comfortable and committed to operate in the new technology environment.

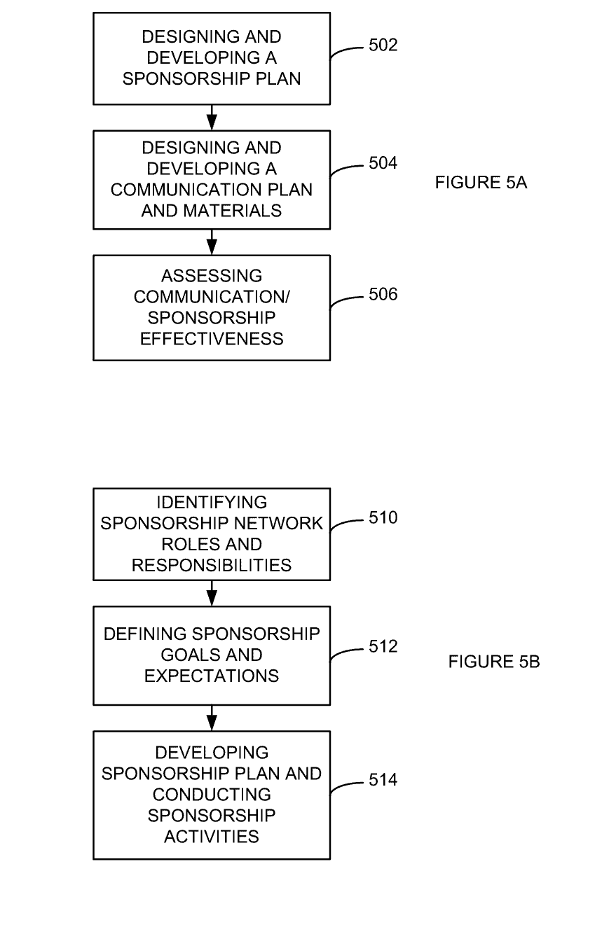

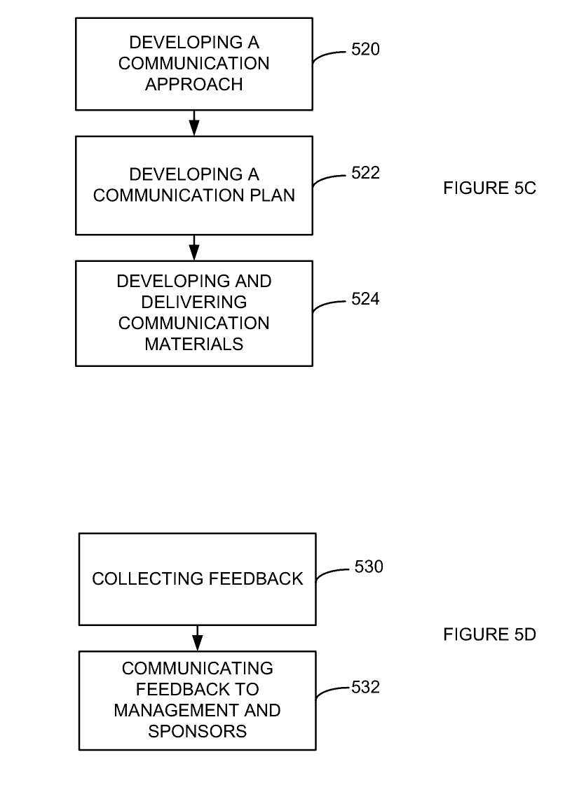

Communications and sponsorship is typically accomplished as shown in FIG. 5A, by designing and developing a sponsorship plan at step 502, designing and developing a communication plan and materials at step 504 and assessing communications/sponsorship effectiveness at step 506.

Designing and developing a sponsorship plan of step 502 is further detailed in the flowchart of FIG. 5B. As shown in FIG. 5B, the designing and developing of the sponsorship plan includes identifying sponsorship, network roles and responsibilities at step 510, defining sponsorship goals and expectations at step 512, and developing a sponsorship plan and conducting sponsorship activities as shown at step 514.

Because effective sponsorship is important to the successful implementation of Claim Components, it is desirable that the claims organization build an appropriate support system for those who will be impacted by the transition to the desired operational environment. The support system is typically made up of project sponsors who actively demonstrate their support of the new system and help the stakeholders within the organization to understand the purpose and benefits of the implementation.

To design and develop a sponsorship plan at step 510, sponsorship network roles and responsibilities are identified. The sponsorship network represents a hierarchy of people that sponsor and own the transition to the business processing software, here, Claim Components. The sponsorship network raises the visibility of anticipated changes and builds support ahead of the actual change. Personnel from the executive level within the organization comprise the sponsorship network. Typical sponsorship networks in a claims organization include the head of claims and claim managers, and the chief information officer and claim application leaders. Individuals within the sponsorship network are responsible for allocating the financial, human and other required resources to effectively manage the transition. Such individuals communicate the vision, strategies and concepts behind the change and resolve the high-level issues with stakeholders.

Next, sponsorship goals and expectations are defined as shown at step 512, in order to effectively implement a sponsorship plan. This is accomplished to ensure that all members of the sponsorship network are consistent in performing their responsibilities. Sponsorship goals and expectations may be determined by asking members of the sponsorship network what they want to achieve from the transition, why they want to transition to the new technology, how they want to successfully sponsor the implementation of the technology, and how people within the organization will perceive the change. Further questions may include querying how the proposed implementation may contribute to achieving the business strategy of the organization, to what extent does the target team understand the business goals, and what are the guiding principles of the sponsorship network. It is beneficial when sponsors help to reinforce these goals and expectations, and modify them throughout the transition as business objectives and goals change.

Once the sponsorship network and goals are defined, a sponsorship plan may be developed as shown at step 514. The sponsorship plan identifies key actions which project sponsors may take to ensure project success. The plan typically includes actions for the sponsors and the time frame in which the actions will take place. The sponsorship plan ensures that various levels of sponsorship exist to champion the project throughout the organization, that sponsorship requirements are turned into actionable items to generate visible project support, and that business units have the appropriate level of sponsorship at the local level. In order to effectively implement the sponsorship approach, the sponsors develop support tools and schedule activities to demonstrate their commitment to a successful transition. Such sponsorship activities include executive sponsorship activities and organization-wide sponsorship activities.

Executive sponsorship activities provide executives within the organization with information about the status of the transition. Such activities are typically conducted in steering committee meetings and project sponsor briefings. It is important that executives understand the purpose of the transition, key decisions regarding the transition, a timeframe of the transition, program costs, similar projects which are being conducted by competitors, how groups within the organization are impacted, and the need to keep all individuals impacted by this change informed.

Organization-wide sponsorship activities should also be conducted so that individuals stay informed about the status and key milestone of the technology transition within the organization. Typical organization-wide sponsorship activities may include open houses, department meetings, staff meetings, celebration events (i.e. speeches from executives, photos, videos, etc.), and communications.

Both the executive and organization-wide activities should be conducted throughout the transition period; conducting these types of activities will increase the effectiveness of the overall of the sponsorship effort.

Returning to FIG. 5A, after a sponsorship plan has been designed and developed at step 502, a communication plan and materials are designed and developed as shown at step 504. The designing and development of a communication plan and materials is further detailed in the flowchart of FIG. 5C.

As shown in FIG. 5C, to design and develop a communication plan and materials, project goals and expectations as well as the sponsorship network itself are utilized to develop a communication approach as shown at step 520, develop a communication plan at step 522 and develop and deliver communication materials as shown at step 524. Because communication plays an integral role in the transition to Claim Components, the communication plan provides an action plan and management tool for facilitating, supporting and promoting the key messages that need to be communicated throughout the transition. The communication plan defines audiences, messages, communication vehicles, senders and frequency of the communication activities. Developing the communication plan ensures that relevant, accurate and consistent information is provided to the organization throughout the transition period.

To develop a communication approach at step 520, activities such as defining a framework, identifying the audience, determining the message and determining communication vehicle(s) may be carried out.

Prior to designing a communication plan, a framework is defined to identify the work that will take place in transitioning the organization. The framework includes guiding principles, objectives, scope, definition, assumptions, dependencies and key partners. The guiding principles are foundational activities that the communication and sponsorship teams would adhere to throughout the life of the project. The objectives define the high level business and performance objectives for the employee in the target environment. The scope definition is a statement of the work to be completed by the communication and sponsorship teams. Assumptions are presumed true statements or activities which impact the communication and sponsorship teams or programs. Dependencies are activities or people that the communication and sponsorship teams are reliant upon for success. The key partners are teams, vendors, or people which have responsibilities for communication and sponsorship activities or inputs.

The audience, or recipients of the communications, are then identified and typically consist of those individuals who are impacted by the Claim Components implementation. In a claims organization, such audiences may include field adjusters, adjusters by line of business, regional supervisors, administrative staff, litigation management personnel, contact center personnel, recovery personnel, and underwriting personnel. Further, individuals may include those associated with loss control, the workers compensation unit, the immediate response unit, the special investigation/fraud unit, third party administrators, vendors and agents.

When identifying the audience, it is desirable that all individuals impacted by the transition be identified and grouped according to their needs. It is further important to analyze the size of the audience, the location of the audience, the current communications used by the audiences, how ready each audience is for the technology transition, and recent classes or failures of previous projects within the organization.

Once the audience is identified, key messages should be determined. Such messages may include a big picture message, detailed content messages, logistics messages, and recognition messages. The big picture messages may include information as to the claim operational vision and how Claim Components fit into the organization, the benefits and features/functionality of Claim Components and why it is being implemented, the employee's role in insuring the success of the transition, how the employee can provide feedback and add questions to help smooth the transition to Claim Components, and major impacts resulting from Claim Components in the claims division.

Detailed content may include findings from the business process, gap analysis and the impact assessment, and specific changes as a result of the implementation period. The logistics messages may include training course dates and timelines, road shows and meetings within the organization, and key contacts. The recognition messages may include milestones and key players.

The content of each message may be determined based on the phase of the transition in which the message is being sent. During the design phase, information may be provided to help the audience understand the project vision, scope and development status. Sharing information and identifying user concerns will help gauge the user's awareness and understanding of the change.

During the built and test phases, it is beneficial to change people's perception of the transition from one of doubt to one of comfort. Key messages may focus on describing what Claim Components will do and how it will benefit the audience and the company. This will help the audience understand and begin to accept the change. During these phases claims managers need to demonstrate their support for the transition. Any questions or concerns about the change should be addressed in this phase.

During the transition phase, key messages should focus on what will happen and when it will happen. Sponsors should announce transition, describe the success of the transition and provide support to the audiences. Information needs to be provided to all that are affected by the change. Therefore, obtaining feedback during this phase is critical to the success of the transition.

During the post-transition phase, key messages may focus on reinforcing the value of the new tools and processes to the organization. This phase may also include periodic evaluation of how users are using the system to ensure that they are utilizing all functions of the change navigation tool.

Once the messages have been identified, the communication vehicle(s) are designed. There are many types of communication vehicle(s) which can be used to deliver key messages. Existing vehicles should be identified and analyzed first. Each vehicle should be assessed according to availability, audience acceptance, distribution method and sender, distribution frequency and cost of use. Some examples of communication vehicles may include memorandums, newsletters, email messages, website information, office visits, forms, status meetings, open houses, voice mails and communicators.

The type of communication vehicle used may depend on how the organization typically communicates to its members. In the claims environment, establishing a communicator (also referred to as a champion) for each claim office is beneficial. The champion is responsible for serving as a contact between the project team and the claim offices. The champions are given presentations to share with branch personnel to inform, educate and motivate the people within the branch about the upcoming technology transition. Champions may also be trained in advance of their office so that they can support instructors throughout the training classes. Characteristics which may be considered in selecting an effective champion may be his credibility with users, problem solving abilities, strong claims skills, familiarity with the claims system, effectiveness as a coach, and strong communication skills. A sufficient number of champions should be appointed. In a claims organization, typically one champion is assigned for each 20 to 30 claims professionals. The Change Navigation Toolkit may provide a sample deliverable communication strategy document which provides to the communication and sponsorship team an example of a claims organization communication strategy.

After the communication strategy and approach have been developed at step 520, a communication plan is developed as shown at step 522. The communication plan outlines the communication activities that will be executed for each audience. The plan allows the project team to identify the audiences who will be receiving formal project communications, key messages to be delivered at each communications event and the communication vehicle to be used to deliver each set of messages. The project team may further identify target delivery dates for each communication event, and individuals responsible for developing the content of the communication materials, organizing the content and facilitating reviews with management, and delivering the communications to each audience. A communication plan ensures that the communication needs of all audiences are identified and planned, that each message comes from a source of integrity and accuracy, that each message is delivered within the appropriate timeframe, and that the appropriate resources are identified for communicating the forecasted messages. The Change Navigation Toolkit may include a sample deliverable communication plan as an example of a claims organization communication plan template to be utilized by the communication and sponsorship team in designing and developing the communication plan.

Communications and communication material may be developed and delivered, step 524, throughout the lifecycle of the transitions to communicate key messages to target audiences. The content of the communication materials depends on what is appropriate for the organizational culture, the purpose the materials are meant to achieve, the communication budget and the key messages defined in the communication approach. Once the communication materials have been developed, they should be reviewed and approved by sponsors and subject matter experts and delivered according to the communication plan. The Change Navigation Toolkit may include a sample newsletter for use by the communications and sponsorship team in generation of a claims organization newsletter.

Returning to FIG. 5A, after the communication plan and materials have been designed and developed at step 504, the communication/sponsorship effectiveness is assessed as shown at step 506. Assessing the communication sponsorship effectiveness is further detailed in the flowchart of FIG. 5D.

As shown in FIG. 5D, to assess the communication/sponsorship effectiveness, the communication plan and materials and sponsorship plan and activities are utilized to collect feedback as shown at step 530, and communicate the feedback to management and sponsors as shown at step 532. Assessing and evaluating the effectiveness of the communication and sponsorship plans should be done to identify continuous improvement opportunities for both plans. One way to measure the effectiveness is to solicit feedback from targeted audiences. The feedback may then be used to modify or enhance communication and sponsorship activities by reinforcing key messages and addressing specific areas of concern.

In order to collect feedback at step 530, the desired outcomes are determined, as is determined when communication and sponsorship should be assessed, the needs to be assessed are determined, and the mechanisms for assessing communication and sponsorship are identified.

When collecting feedback, it is beneficial to first determine the desired outcomes. This is done to ensure that the right content is assessed and that the feedback obtained is relevant and useful. Examples of desired outcomes may be to meet the needs of the audience at any given point and time, to modify communication and sponsorship activities to reinforce key messages and to address areas of concern.

To determine when communication and sponsorship should be assessed, feedback should be solicited before, during and after the transition to the desired operational environment to track the level of commitment of the audience. Key points during the transition when communications and sponsorship should be assessed are during pre-transition, following key communications or sponsorship events (i.e. newsletters, road shows, etc.), during and following training activities, and following the transition.

Next the needs to be assessed may be determined based on the desired outcomes. Examples of items to assess include the audiences understanding of the key messages and benefits of the transition, attitudes toward the transition (i.e. commitment), the audiences involvement in the transition, and belief in the success of the technology transition. When developing feedback questions, guiding principles may be employed, such as be general with the feedback questions, leave the door open for unsolicited negative and positive comments, and phrase questions in a statement form rather than asking for “yes” or “no” responses, to allow associates to express how they feel about the change. Further guiding principles may include using ratings that do not allow for “middle ground,” and realizing that open-ended questions may take more time to answer, where time is something which employees providing the feedback may not have.

In order to identify the mechanisms for assessing communication and sponsorship, it is important to be aware that there are many types of feedback mechanisms that may be used to assess communication and sponsorship. Existing mechanisms should be identified and analyzed first. Each mechanism should be assessed according to availability, audience acceptance and cost of use. Typical feedback mechanisms may include department status meetings, on-line bulletin boards, questionnaires and interviews.

The department status meetings are periodic meetings which provide status of all departments within the organization. Each department varies in its commitment to change, so departments status meetings may be used to assess communication and sponsorship effectiveness within each department. The on-line bulletin board is an anonymous web-based feedback tool to post any concerns or questions that the particular audience may have. For example, after a newsletter is sent out, recipients will be asked to provide feedback via the on-line bulletin board to assess the effectiveness of the newsletter. Questionnaires contain questions which are to be answered anonymously by the audience. Questionnaires are typically the most effective when administered after events such as training. For example, after an office kick-off meeting, participants are requested to fill out questionnaires to assess the effectiveness of the meeting. Interviews are “ask and answer” sessions between two people or between small groups and allow for detailed discussion with follow-up and clarifying questions. Since agents, vendors and third-party administrators are typically unable to provide feedback on a periodic basis, interviews with management may provide effective feedback from such parties.

There are many different types of feedback mechanisms which may be used to assess communication and sponsorship effectiveness. Existing mechanisms should be identified and analyzed first. Each mechanism should be assessed according to availability, audience acceptance, distribution method and sender, distribution frequency and cost of use.

Once the feedback is collected at step 530, the results need to be communicated to management and sponsors as shown at step 532. Management and sponsors should then use the information to address specific issues or concerns among various audiences. This is done by modifying and/or enhancing communication and sponsorship plan/activities.

### Business Content Portion

The business content determined through the Business Content portion 208 is the data that is utilized in configuring the business process software for use in the desired operational environment. For the Claims Components implementation described herein, it is the data that populates Claim Components libraries with information that customizes the technology to allow a claims organization to achieve specific, targeted business objectives. The Claim Components solution leverages an event processor in conjunction with the business content to automate administrative tasks and ensure the consistency across the claims setting process. There are eventually four types, or streams, of business content including tasks, file notes, forms and correspondence, and organizational entities.

The tasks are action items required to settle pending claims generated based on the attributes of the claims. The file notes are preformatted notes which can be attached to pending claims in order to record claim handler input. The forms and correspondence are preformatted forms, letters, memos, documents, etc. that are generated for existing claims and used to communicate with agents, insureds, claimants, vendors and state regulatory agencies. The organizational entities include information about the claim organization, claim performers and the relationships within the organization. Once the business case citing main objectives of the Claim Components implementation is defined and the To-Be process model development is underway, business content activities may begin.

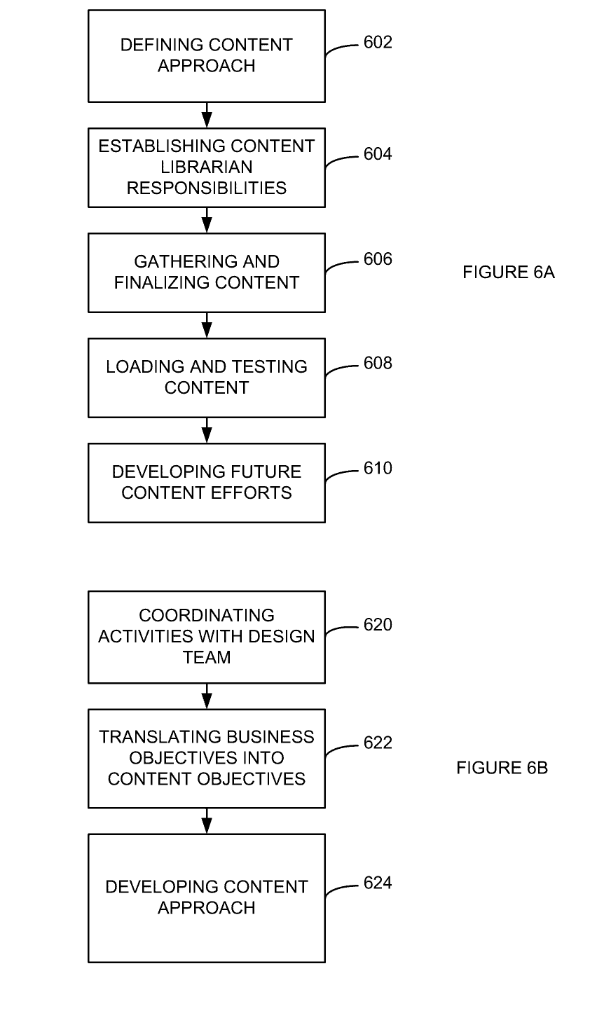

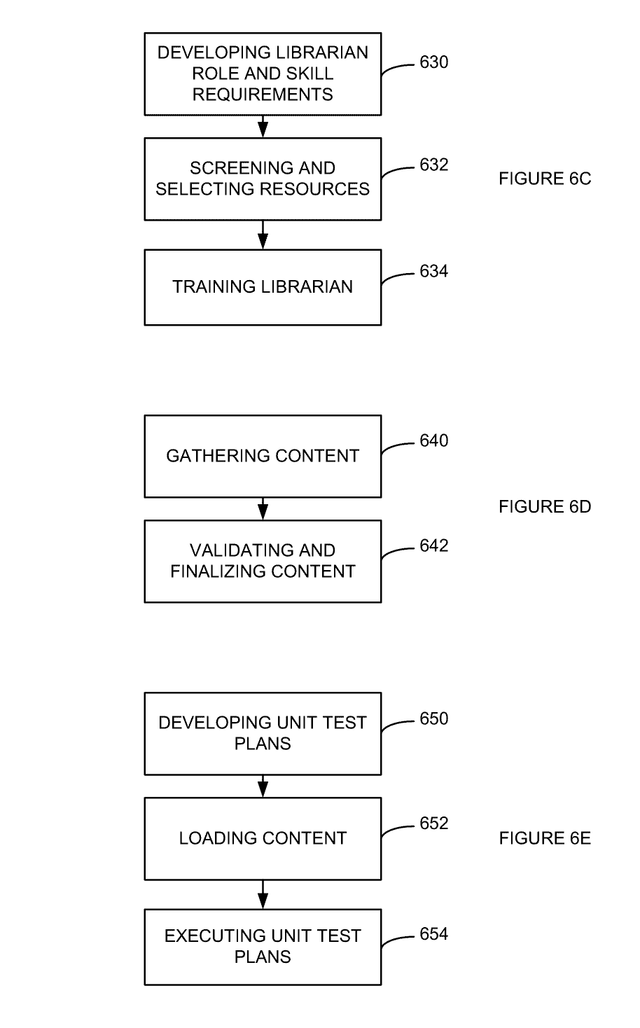

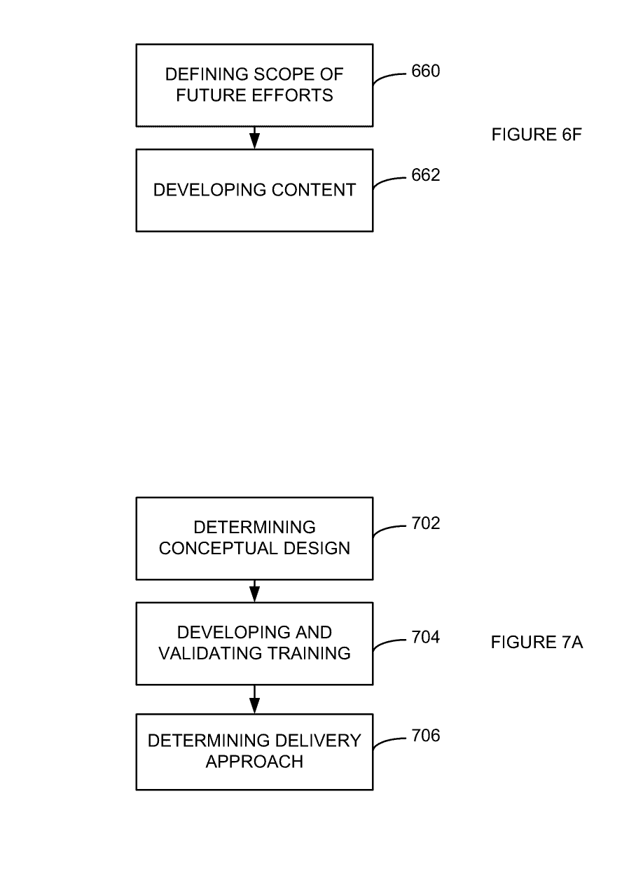

The flowchart of FIG. 6A illustrates methodology for Business Contents portion 208. As shown in FIG. 6A, in order to accomplish the business content activities, a content approach is first defined at step 602, content librarian responsibilities are established at step 604, content is gathered and finalized as shown at step 606, the business content is loaded and tested within the organization at step 608, and feature content efforts are developed as shown at step 610.

Defining the business content approach of step 602 is described in further detail in the flowchart of FIG. 6B. As shown in FIG. 6B, the business case with Claim Components implementation business objective and the To-Be business processes are utilized to define the business contents approach by coordinating activities with the design team at step 620, translating business objectives into content objectives at step 622, and developing the content approach as shown at step 624.

In order to coordinate activities with the design team at step 620, the business content team and the Claim Components technical design team should reach agreements on the scope of the two teams and the process which each will use to keep the other informed regarding Claim Components project progress. At a high-level, the business content team is responsible for gathering, loading and testing the functional content that the technology team will use as an input for Claim Components product testing. Such coordination points may include agreeing on the level of detail to be captured with pre-formatted data field menus on content forms, coordination of their respective development in order to avoid timing issues throughout the testing, and communication regarding status of the content development efforts. Further coordination points may include definition of issue escalation, decision-making and dispute resolution processes, and the development of separate environment/databases so that content components may be saved separately from non-content specific components (i.e. it is desirable that the development environment meet Claim Components design specifications).

As mentioned above, the business content customization of the Claim Components allows for achievement of specific targeted business objectives. In order to create a foundation for future content efforts, the business objectives, outlined in the business case, should be translated into high-level business content requirements, or guiding principles, as shown at step 622. Considerations for identifying high-level business content requirements may include what the specific line-of-business needs are for the organization, contents required by federal and state regulators, whether there is content that is either high in frequency of use or high in importance to claim settlements, and what the specific business content requirements are resulting from the To-Be claims processes. Further considerations may include determining which content will have the highest degree of impact on accomplishing specified business objectives, and which content has immediate claimant, insured or agent impact.

Next, a business content approach should be developed for each stream of business content as shown at step 624. Each approach should align the steps necessary for end-to-end development of the specific content stream, from gathering content data to unit testing. Each approach may address considerations such as a statement of scope, methods used to document specific content stream data, sources of content information, process for loading content into Claim Components, the timeline for content stream development, and issues/risks which could impact content development. The Change Navigation Toolkit may include a sample business content task approach, business content file notes approach, business content F & C approach, and business content organizational entity approach, which provide the business content team with example content stream specific approaches which may be utilized in the transition period.

Regarding the statement of scope, the statement of scope defines the target number of content items to be developed within each content stream. These numbers should be determined based on high-level content requirements determined in the previous step. Scope statements may include a numbered list of tasks, file notes, forms and correspondences, and organizational entities to be developed. The scope statements may further include timeframes for subsequent content development efforts aligned with business objective and design team timelines, and resource requirements.

To determine the method for documenting specific content stream data, templates should be developed for capturing the content-specific information. The specific data fields which define each content stream should be identified and outlined in template format by line of business and/or claims process. These templates will be populated with content data and loaded into the system. Data fields may include but are not limited to content item name (i.e. task name, form name), content item description and key stakeholder role. Further data fields may include trigger events/claim attributes, display date, lengths of display, requested follow-up, content input, and rules which dictate timing and frequency of content generation or enablement. The Change Navigation Toolkit may include a sample task template and task template format for validation which may be utilized by the business content team in documenting the specific content stream data.

The specific content information is then determined. Specific content information may be gathered from a number of sources depending upon the business content stream. The sources in corresponding collection methods should be stated in the approach document for each content stream. For content streams such as tasks, forms and correspondence and file notes, sources of content information may include focus groups with subject matter experts, interviews with claim performers/business users and existing process workflows. Further sources may include claims studies highlighting best practices surveys, Claim Components standard content loads, Claim Components design team, state and federal regulations and information on claimant, insured and agent needs. For the organizational entities content stream, sources of information may include interviews with human resource professionals, organization charts, corporate directories, payroll, and enterprise resource planning modules.

A process for loading content into Claim Components should then be outlined. Loading content is coding the stream-specific data into the Claim Components application according to development guidelines specified by the Claim Components technical design. The business content team should review the technical design and specified loading processes in terms of key steps, guidelines, expected outcomes, error-handling methods and pre-formatted functions and variables.

A timeline for content stream development should then be created to guide efforts and assess progress of the effort. The timeline should specify the key development activities that need to be performed, the inputs needed to perform them, and the expected outputs. Potential risks which may prevent the development of content stream by the pre-determined deadlines should be identified and documented with any known mitigating actions.

Each approach should be documented and passed on to subject matter experts and the appropriate stakeholders for validation. The four documented, validated approaches should then be given to senior management and the program management officers for final approval. Each finalized content approach will dictate the standard procedure for developing the respective content streams.

Returning to FIG. 6A, after the content approach is defined at step 602, content librarian responsibility should be established as shown at step 604. Establishing the content librarian responsibilities is detailed further in the flowchart of FIG. 6C.

As shown in FIG. 6C, the content librarians responsibilities are determined by using high level content requirements and the content approach documents to develop the librarian role and skill requirements at step 630, screen and select resources at step 632, and train the librarian as shown at step 634.

The content librarian responsibilities are established for each stream of business content. The librarian(s) are responsible for the post-transition maintenance of the business contents. Each stream of content should have a resource that is accountable for additions, deletions, or modifications to the existing base of content and system functionality. Librarian(s) should be designated prior to content development so that the selected individual(s) have exposure to and education regarding all aspects of content development for future enhancements and upgrades.

The librarian role and skill requirements are defined at step 630, where the business content team, working with claims management, should determine the key responsibilities and skill requirements necessary to keep the business content current and accurate. Additionally, claims management should determine the extent to which the librarian(s) are involved in functions other than content maintenance. This will assist in determining the number of librarians required and whether the librarians are full- or part-time resources after Claim Components is implemented. Claims management and human relationships, performance evaluation criteria, compensation details, and training requirements are defined for the librarian role. The Change Navigation Toolkit may provide a sample business content role-F & C librarian business content role-task designer, and business content role-content manager documents which may be utilized by the business content team in defining specific skills and responsibilities of the content librarian.

In screening and selecting resources at step 632, the role specifications should be passed on to the appropriate business organization personnel, for example human resources or management personnel of the business organization, for selection and hiring.

The librarians are then trained as shown at step 634, where selected librarians are trained for the responsibilities in their role description. The content librarian is responsible for on-going additions, deletions and modifications of system, and should be trained on the Claim Components system and functionality, how content development relates to, and impacts the system functionality, and supporting applications. Further, librarians should be trained on content generation and business processes, soliciting and managing feedback and role specific skills not listed above per the respective responsibilities.

Returning to FIG. 6A, after the content librarian responsibilities have been established at step 604, business content is gathered and finalized as shown at step 606. The gathering and finalization of business content is described further in the flowchart of FIG. 6D.

As shown in FIG. 6D, the content approach for each stream of business content, data gathering templates, existing event and attribute lists for task development from the design team are used to gather forms and correspondence, tags lists and tag rule documents from the design team, and a current list of pre-formatted file notes from the design team are used to gather the business content as shown at step 640, and validated and finalized the business content at step 642.

The business content should be gathered at step 640 for each stream according to the processes outlined in the business content approach. To identify and gather business contents for the first phase content load, the content team should execute the process outlined in the approach for each stream. The approach details the preferred methods for gathering business content data and populating the developed content templates. The Change Navigation Toolkit may provide an organization relationship, spreadsheets, an event definitions document, and a F & C tag rules document which sets forth various guidelines for gathering additional information and specific business content.

Next, the content data should be reviewed and validated, as shown at step 642, by appropriate user populations to ensure completeness, accuracy and consistency with the high-level content requirements and system functionality. Working sessions may be conducted with a standard agenda to facilitate the validation process for each stream of content, working session participants should include members of content team to facilitate and document sessions, key process stakeholders and/or performers, subject matter experts, and supervisors. Considerations which may be addressed in the working sessions include whether the content meets the business requirements, either the content is complete and accurate, whether the content aligns with the initial goals of the business content development effort, whether the appropriate level of detail is present, and whether there is information missing. Based on the results of the validation session additions, deletions, or modifications should be made to the content. The validated and modified content should be distributed to senior management for final approval. Once the content has been approved, it is passed on to key process stakeholders and the content team to load into the system.

Returning to FIG. 6A, once the content is gathered and finalized at step 606, the business content is loaded and tested, as shown at step 608. The loading and testing of business content is shown in further detail in the flowchart of FIG. 6E.

As shown in FIG. 6E, the business content is loaded and tested using the business content approach for each stream of content, the populated templates of initial content for each content stream, Claim Components technical design protocol, and approval to proceed with content load and to develop unit test plans at step 650, load business content at step 652, and execute unit test plans at step 654. The content team is responsible for loading the content data into Claim Components by coding the content data into the application. Once the data is loaded, each content stream should be tested against the system functionality requirements.

The unit test plans should be developed at step 650 by the content team. The unit test plans typically outlines the steps necessary to test the functionality and error handling of each content stream. Test plan development includes developing a list of test goals or expected results for each content stream, where test goals may include content format, goals as to pre-populated data fields and the goals as to content functionality. Specific examples for the content format may include whether the task interface meets Claim Components design specifications, the goals of pre-populated data fields may include tasks such as determining whether drop-down menus are correctly populated and whether task display attributes match the conditions on the claim. Content functionality task goals may include activities such as determining whether the task rules are properly functioning, whether the task comes up when all of the task conditions are not met, and determining whether the task displays based on the proper event trigger.

Further test plan development steps include establishing and verifying the test environment and specific test steps, creating a test plan with scheduled milestones and timeframe estimates, identifying potential problems and corresponding mitigation action items and documenting test plans. The Change Navigation Toolkit may include a sample business content test plan-file notes, a business test plan-F & C, and a business content test plan-tasks documents which may be utilized by the business content team as sample test plans for each content stream.

Once the unit test plans have been developed, the team can load business content into Claim Components as shown at step 652. The content team is responsible for creating the business content templates, for example utilizing an existing word processing program or other text editor, as well as coding the data fields and tags rules that enable the content. As this may be a time-intensive process, the Business Content team should be skilled in the particular word processor or text editors utilized in developing the required templates in a timely manner. The populated content data templates for each content stream contain the required data to code into the system. The team should follow the process and timeline specified in the approach to code the content into the system and conform to the guidelines required by Claim Components technical design specification. It is desirable that the content team have an independent development environment which is separate from that of the system design team in order to prevent the loss of content data.

Once the content has been loaded at step 652, the unit test plans (developed at step 650) should be executed for each business content stream as shown at step 654. Executing the unit test plans, steps such as preparing the testing environment, testing content streams, evaluating results and re-testing as needed, and maintaining and updating test plans, cases, environment, and “test ware” should be performed.

In preparing the test environment, appropriate test data (claims) should be created in the system, and it should be ensured that the event processor and generator are functioning. In testing the content streams, unit test plans should be executed, and specific claims should be assigned to each tester. In evaluating the results and re-tests, it should be determined if actual result match the expected results, whether an error occurs, and if an error occurs, the error should be isolated and corrected, and the content should be re-tested until actual results match the expected results. To maintain and update test plans, cases, environment and test ware, the test plans should be modified to accommodate new information, redundant test or outdated steps should be eliminated, and the test environment should be modified as necessary.

The tested, functional content components should be passed off to this assigned team for Claim Components solution product tests. It should be noted that there is a cross-dependency that exists at this point of development. The design team needs to have completed and tested content streams and order for the content team test environment to be fully functional. Therefore, it is imperative that the content team and design teams coordinate their efforts and timelines.

Returning to FIG. 6A, once the test content has been loaded and tested at step 608, future content efforts are defined as shown at step 610. Defining the future content efforts is shown in more detail in the flowchart of FIG. 6F.

As shown in FIG. 6F, future content efforts are defined using fully functioning, tested content components, developed test plans, business content requirements, and content approach documents, in order to define the scope of future efforts at step 660, and develop future business content at step 662. It is the responsibility of the content team to define future content efforts. This entails defining the scope of the future development efforts and redefining the content approach.

After the first phase of content development has been completed and the claims technology solution is functional, the content team should define the scope of future efforts, as shown at step 660. The number of implementation phases (or content loads) necessary to accommodate the additional business content should be determined. Typically, there are no more than three phases or loads per year. Content for consideration in future releases includes content that was generated but not included in the first release, feedback from content users and new claim technology solution releases or updates. The scope document should include a list of tasks, file notes, forms and correspondence, and organizational entities to be developed or modified, timeframes for subsequent content development efforts aligned with business objectives, resource requirements, and revisions to approach documents based on the results of the first content load. Once completed, the scope document should be passed to management for approval.

Once management has approved the scope document, the content team should begin subsequent efforts by developing content as shown at step 662. Efforts include reviewing each content approach document to accommodate new information and/or business objectives. Once the necessary modifications are made to each content approach document, each approach should be validated and approved. Once approval has been granted, content development may be processed with development efforts per the finalized approaches. Change Navigation Toolkit may include a continuous improvement plan document which provides the business content team with details on developing future content.

### Training Overview Portion

Training portion 210 provides business organization employees with the knowledge, skills and tools required to successfully transition to and perform within the target operational environment. Training minimizes the time it takes for employees to assimilate the new technology and modified business process and maximizes employee productivity within the target operational environment.

Minimizing the employee's time to assimilate the target operational environment and maximizing the employee productivity may be met using training and performance support methods and tools including web-based training, instructor-led training, goal-based training, on-line coaching, electronic and paper-based job aids and the use of a help desk. One or more of these methods/tools may be utilized to create an overall training program addressing the specific productivity and performance objectives of a job.

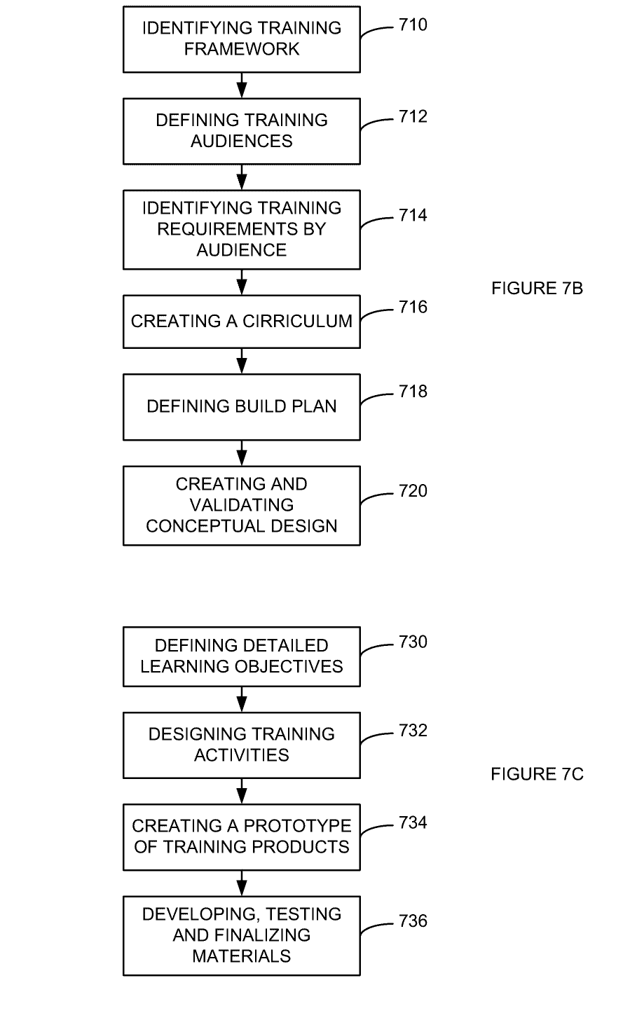

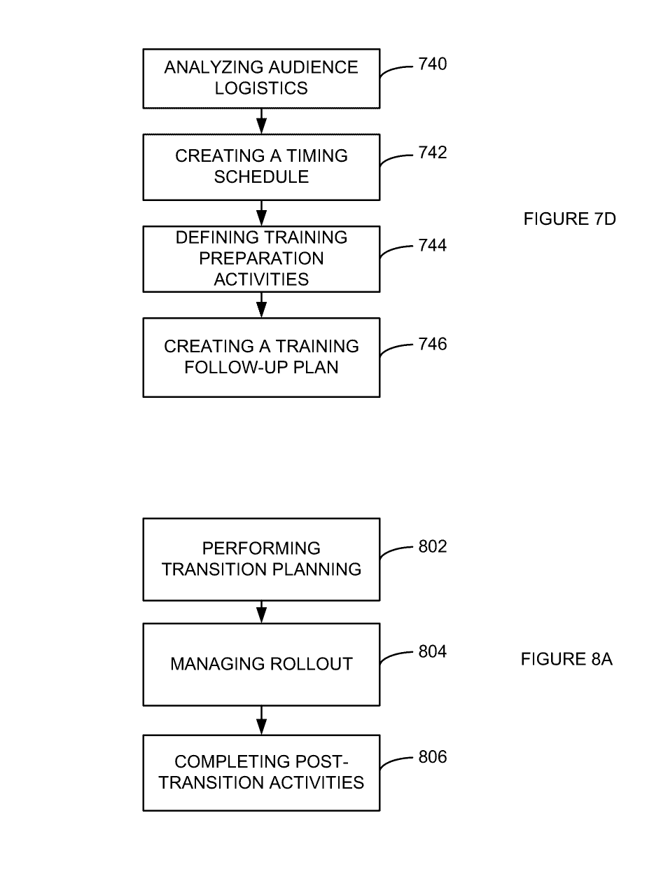

Methodology for implementing the training portion 210 is illustrated in FIG. 7A, and includes determining a conceptual training design at step 702, developing and validating the training at step 704, and determining a delivery approach at step 706.

Determining the conceptual training design at step 702 is described in further detail with reference to the flowchart of FIG. 7B. The conceptual training design determined at step 702 documents the clear and specific objectives and training activities related to a Claim Components implementation. The conceptual training design aids in organizing and guiding future training activities. Using the impact assessment, the technology design (i.e. user interface documents), and role designs (where applicable), the conceptual training design is determined. This is accomplished as shown in FIG. 7B by identifying a training framework at step 710, defining training audiences at step 712, identifying training requirements by each training audience at step 714, creating a curriculum at step 716, defining a build training plan at step 718 and creating and validating the conceptual training design at step 720.

When identifying a training framework at step 710, it is important to note that the training framework defines the overall scope and objectives of the training program. The objectives define the high level business and performance objectives for the employee in the target operational environment. Objectives typically answer the question “What specific outcomes are desired as a result of the training program?”. Objectives are typically based on concepts that the claims department views as a priority (i.e. customer service, operational efficiency, etc.). For example, a Claim Components training objective may be to design and implement a training program which focuses on enabling employees to provide superior internal and external customer service.

Scope is a statement of the training work to be completed. In a Claim Component implementation, the training scope typically contains three components: technology, processes and roles. Within the scope definition, training requirements are typically defined within each of these categories.

Defining the training audiences at step 712 is accomplished by analyzing the information about the business organization employees impacted by the Claim Components implementation, including their skills, knowledge, experience, current job responsibilities, geographical location, and number of people per job group. This information is helpful when drawing key training inclusions such as the skilled/knowledge gaps between the current and target environments, basic technology and the computer skills required, level of support required, the most appropriate training methods, and content.

Claim audiences may be identified by reviewing the impact assessment and confirming discussions with Claim Component experts and the business project team members. The Claim Component experts can share who is typically impacted by the new technology and how they are typically impacted. The business resources can then translate typically impacted groups into organization specific roles/jobs, titles and identify who supports each of the impacted groups.

Audiences who are typically impacted by the business organization transition include field adjusters, adjusters by line of business, regional supervisors, administrative staff, litigation management personnel, contact center personnel, recovery personnel, underwriting personnel, loss control personnel, worker's compensation unit personnel, immediate response unit personnel, special investigation unit/fraud unit personnel, third party administrators, vendors and agents. Once the impacted audiences have been identified, high-level audience profiles may be created for each impacted audience through discussions with business project team members. The audience profiles may outline key roles and responsibilities for each audience. For example, the audience profile for claims management may read, “claims management is responsible for the management of personnel including hiring and training within their unit or office; they are also responsible for the management of financial outcomes and conducting marketing calls with business partners to attract and retain customers.” The audience profiles are used as an input in determining audience training needs and the number of courses or modules that should be developed. The Claims Navigation Toolkit may include a sample training audience document for describing to the training team sample audience job descriptions.

Audience logistical information may be gathered and organized so that it can be leveraged in the future. Key information typically includes a number of claim offices, names/location of claim offices, the total number of employees by office, the number of employees by job within each office, the lines of business within each office, and a number of employees by line of business within each office.

After defining the training audiences at step 712, the training requirements are identified at step 714 by each audience by identifying the knowledge and skill gaps of the various training audiences. A sample skill gap for a claim professional is Claim Components navigation skills. Training and performance support is then designed to address and close these gaps so that current employees receive an adequate amount of training to successfully perform in the new environment. Three activities useful in defining training requirements include using the impact assessment to identify all of the skills and knowledge that employees will require, reviewing the audience profiles to understand which audience will require each of the new skills/knowledge based upon current responsibilities, and grouping the audiences together based upon similar training needs.

A training curriculum is then created at step 716 to transform the list of training requirements into training modules or logistical “chunks” of requirements. For each training module, the curriculum provides a high-level description of the contents and the recommended delivery method (web-based, instructor-led, job aid, etc.).

One consideration to make when creating a training curriculum is whether the requirements should be addressed through training, performance support, or a combination of both.

Training may be used to teach “how to” skills, for example Claim Components system navigation such as how is a claim assigned using Claim Components, conversion and clean-up procedures such as how a file is converted from an old system to Claim Components, and key process changes such as how correspondence is sent using automated forms. Performance support may be utilized to advice employees on “what” to do and may provide information to make a task easier or more efficient, but usually does not teach employees “how” to do their jobs. For example, performance support may include job aids for the most common transactions such as signing on and signing off of Claim Components, searching for a claim, etc., and for on-line help for frequently asked questions and troubleshooting techniques.

Another consideration is to take the training content and group information into training modules (logical “chunks”) and define specific learning objectives for the modules. For example, a training module may include information regarding system navigation including navigation within the desktop, toolbars, and claim tree. Module learning objectives may include information such as launching and navigating through Claim Components using the desktop, toolbar and a claim tree.

After the modules and learning objectives have been defined, a delivery method for each module is identified. The performance support requirements should also be assigned a recommended delivery mechanism or tool. There are a variety of delivery options with associated benefits. The Change Navigation Toolkit may include a sample delivery options document describing to the training team information and guidelines for evaluating and recommending a delivery method for the training.

As the delivery methods are selected, it is beneficial to choose those that the organization is comfortable with and those which the organization can support. Some considerations in determining the delivery method are determining how the claims professionals are currently trained, which type of training facilities are available and the capacity of the facilities, whether there are any standard procedures for training, registration and tracking and what the existing channels for performance support and training distribution are. Further considerations include what the current employee turnover rates are, and how disbursed the training audiences are as well as how many training locations there are. The Change Navigation Toolkit may provide the training team with a sample curriculum document for use in creating the training curriculum.

After the training curriculum has been created at step 716, training build plan is then defined as shown in step 718. A training build plan is the approach, timing and budget for the management and development of training modules in performance support tools. In defining the training build plan, various decisions are typically made such as whether a build plan will be purchased and modified, or whether a customized training solution will be developed, and who will be the builders for the build plan to develop or modify the training program. Builders may be an internal training group or an external vendor. For example, where internal development is desired, and where a business organization has a learning and development or training department with skilled training developers, such a department may be the best option as the builders. Utilizing internal development is beneficial in insuring that training materials are consistent with the company's culture, and leveraged training techniques that the employees are familiar with and reduce developmental costs.

Where the organization either does not have an internal training department or has an internal training department that lacks the capacity or capability to develop/modify the desired training materials, a vendor may be employed to be the builder. In this case, external development occurs. Selection of the most appropriate external developer, or vendor, should be based on vendor experience and expertise, reputation, and the ability to deliver materials within the designated timeframe.

After the development approach and builders are defined, a detailed development schedule with key development, validation, testing and final deliverable milestones should be created and incorporated into the change navigation workplan. Further, considerations as to the budget for training development should be made such as what tradeoffs need to be made in order to stay within a budget, and whether speed is more important than cost for the training. Further, it should be considered how training materials will be validated. Some considerations here are what steps does the process include, who are the subject matter experts, and who will manage the validation process. Accuracy of the training content is an important factor to the success of the overall training program. As a result, it is beneficial that each training component undergo a detailed and structured review process.

The final activity in creating a conceptual design is to create and validate the conceptual design, as shown at step 720, by packaging all of the information and deliverables from the conceptual design determination in a format that can be shared and validated with management and other interested and impacted parties.

Returning to FIG. 7A, after a conceptual training design is determined at step 702, the training may be developed and validated as shown at step 704. Training development involves the creation and validation of the content within each training module and performance support tool. Determining the delivery approach of step 706 is described in more detail in the flowchart of FIG. 7C. Using the conceptual training design, training is developed and validated by defining detailed learning objectives at step 730, designing training activities at step 732, creating a prototype of training products at step 734, and developing, testing and finalizing the training materials at step 736.

As training development efforts begin, detailed learning objectives are defined at step 730, which designate the desired performance outcome or result of a specific training topic within a module. Detailed learning objectives typically answer the statement, “at the end of this training module, participants should be able to . . . ”. The detailed learning objectives may be used as a guide for training developers when identifying the content to be included in training modules, as a means of providing training participants with a clear definition of what is expected of them, and as a primary basis for measuring and testing employee retention of information and performance.

As learning objectives are being defined, it is important to note that there is an endless amount of information which can be included in the training program but a finite training timeline. A goal may be then to identify just the right amount of training—a balance between critical and “nice to know” content. Some items which may be included in the training program are skills, difficult tasks (or tasks that have changed significantly from the system operating under the existing operational environment), and common exception procedures. Additionally, rarely performed tasks and exception processing may, but need not, be potentially addressed at this stage, however, may be addressed through job aids or other performance support tools.

For a training module such as system navigational (including desktop, toolbar, claim tree), some module learning objectives may include launching and navigating through Claim Components using the desktop, toolbar and claim tree. A delivery method for this training module may be web-based training where detailed learning objectives include launching, Claim Components, describing the functionality of each desktop icon, articulating the abilities of the toolbar, and describing the hierarchy of the claim tree and the item within each level (policy, insured, claimed, claimant, line). The Change Navigation Toolkit may include a learning objectives document which sets forth further detailed learning objectives that may be utilized by the training team.

Using the identified training modules, module objectives, delivery methods and detailed learning objectives as a foundation, training activities which will take place within each module are defined as shown at step 732. Training activities facilitate achievement of the learning objectives, thus, if an activity does not add value to the learning experience, it should not be included. The complexity level of training activities is a key consideration, that is training activities should be natural and intuitive to the learner, and at the same time, complicated enough to keep the learners motivated without causing frustration. Learning activities may be developed by carrying out various activities such as reviewing the training module objectives, delivery method and detailed learning objectives, by identifying appropriate learning strategies (i.e. case studies, simulations, games, etc.) and defining in more detail what the learner will see and what they must do, step by step. Further, learning activities may be developed by determining at which points in the activities the learning objectives are accomplished and how this is validated (i.e. testing/certification tools), and by determining the needed support resources (i.e. reference manuals, job aids, coach, peer) and how and when they will be made available to participants. A consideration for designing training activities may include the consideration that training should not only reinforce how to use the system, but rather it should also address how the system transforms and enhances the way employees work. For example, a teaching point may include, all communications relating to handling claims may be done via the system capabilities (file notes and tasks), that other communication vehicles like Lotus Notes or email should not be used for “claim folder” communications.

A prototype of training products is then created as shown at step 734. Preparing the prototype of a component to the training program to illustrate the format, user interface, etc. of the finished training product can be an efficient and effective method of evaluating the proposed training with management of the business organization. The prototype is beneficial to insure proper sign-off on the “look and feel” of the finished training product before making the full investment in developing the entire product. For classroom training, a relatively stable activity, chunk of content, or other learning component may be selected for the prototype. It may be beneficial to develop a low-fidelity prototype by creating a visual representation (i.e. writing, sketching, drawing) of the component. Once the prototype has been approved, it may be used as the shell or template for the rest of the program to insure consistency.

With computer-based training, a storyboard may be created which provides the detailed content and interactions of each screen of the business process program running on the automatic computer system. Storyboards present the text layouts, graphic or icon requirements, animation needs, and other display issues. They indicate learner control functions and branch, feedback and responses, and other items which may be necessary to alter the course. Storyboards may be used as blueprints from which the programmers will create the course or activity.

In order to develop, test and finalize the training materials as shown at step 736, the foundation is created for the development of the training materials and performance support tools. Development includes taking the prototype templates (with management feedback incorporated) and populating them with accurate training content such as learning objectives, activities, procedural information, etc. The review process identified in the conceptual training design may then be executed and the feedback and comments received through the process are incorporated into the training materials.

Where training databases were identified as a practice tool in the instructional strategy, such a system may be developed, loaded with content and tested at this point. It is important to note that the utilization of a training database may be an extremely effective tool, however, the development effort for providing practice in a training database may be a significant undertaking. The Change Navigation Toolkit may include a training database job aid document useable by the training team in carrying out training utilizing a training database.

Testing or certification materials may also be developed to insure that the learning objectives have been accomplished. It is important that both training participants and claims management have a clear understanding of training participant's ability to successfully perform in target operational environment.

Further, if time permits, training materials may be tested. Testing the training materials allows verification that each training product meets stated learning objectives and that the overall training program meets the performance objectives for the implementation. In order to test the training materials for the products, the test is planned by identifying test participants, test method and expected results, the test is prepared for by creating assessment tools, scheduling participants and equipment for the test, and preparing facilitators, and the test is executed by delivering training materials to the test participants. After the training products have been tested, the materials may be revised to reflect any feedback and data gathered throughout the test. After revisions have been made, the products may be packaged and prepared for production and distribution.

Returning to FIG. 7A, after the training has been developed and validated at step 704, a delivery approach is determined, as shown at step 706. Planning the delivery or roll-out of training may be important to both the success of the training program and the overall claims transformation. Introducing training to employees is often a complicated and logistically complex process which is influenced and dependant upon many other activities, events and factors. Accordingly, training delivery plans and tools should be shared and tightly integrated with transition planning efforts. Determining the delivery approach is described in more detail in the flowchart of FIG. 7D.

Using the training conceptual design and training program materials, the delivery approach may be determined by analyzing the audience logistics as shown at step 740, creating a training schedule at step 742, defining training preparation activities at step 744, and creating a training follow-up plan as shown at step 746.

In analyzing the audience logistics at step 740, the audience logistics and current training infrastructure determined within the conceptual training design are utilized in determining how the training program can best be rolled-out and the resources that will be required to support the roll-out. Considerations in analyzing the audience logistics include the number of training (or support) resources required for the training, any training facility modifications required, and the duration of the training roll-out. The Change Navigation Toolkit may include a sample roll-out analysis document useable by the training team as an analysis template for analyzing the logistics of each audience to be trained.

A training schedule is then created as shown at step 742, which typically describes the timing and activities associated with the training roll-out. For example, if the training program is to be rolled-out by claim office, the schedule should list the key training dates and activities for each office (training kick off meeting, when training materials arrive, pre-training activities, class schedules, conversion dates and the follow-up training activities).

The training preparation activities are then defined at step 744, and typically include preparing support resources (trainers, champions, field support, etc.) and insuring training facilities and equipment are coordinated. For example, in preparing support resources, a “train-the-trainer” session may be held where the training program has an instructor-led or coach-led training components. The train-the-trainer session is utilized to teach trainers how to be trainers (presentation skills, facilitation skills, handling difficult participants, time management, how to prepare to train) and on the content included within the training program. Where the training program utilizes champions in the training, web-conferences or conference calls may be used in preparing the champions to facilitate the claim office kick-off meeting and for explaining roles and responsibilities throughout the training and transition timeline. Further, depending upon the role of the field support, a scaled-down version of the “train-the-trainer” program may be used. For example, where field support is responsible for serving as conversion and clean-up experts, the content of the preparation session for the field support may focus on such activities.

Regarding preparing training facilities of step 744, it is beneficial that training facilities be prepared and working when the training activities occur. A training preparation checklist may be a useful tool for insuring that all facility requirements have been addressed and tested.

Next, a training follow-up plan may be created as shown at step 746. The delivery of training further includes proactive follow-up. As the transition introduces a significant amount of change through new business processes, job expectations and technology within the business organization, it is beneficial to provide continuous monitoring and employee support as employees adjust to the target operational environment. The effectiveness of the training and performance support may be measured in terms of achieving the performance goals and learning objectives defined in the design phase. This effectiveness assessment is beneficial information which may be used to support revisions of the current and future training and performance support, as well as for the development of new training.

Example recommendations for follow-up activities may include a two-week checkpoint, where a follow-up visit or conference call with the management of each claim office is made two weeks after the transition activities are completed. Key issues and/or problems may be discussed during the visit/call as well as identifying requirements for any re-training necessary. Another recommended follow-up activity may include a 60-90 day checkpoint which is a follow-up visit to each claim office to observe how the employees are performing in the target operational environment and to interview management and employees about any continued issues or re-training requirements. A report may be created based upon the data gathered within each office, where the report is shared with the claims office management and project management.

### Transition Portion

Transition portion 212 creates a transformed claim environment staffed with a highly performing work force, supported through leading-edge technology. Transition is the point of convergence for the Change Navigation, System Testing and Conversion and Technical Architecture activities. Transition typically requires coordination of the outputs from each of these teams and the focus of execution. Transition responsibilities may be divided by teams, including a training, communications, business process, business content, system testing and conversion, and technical architecture teams. The training team may be responsible for the training delivery approach, that is how training will be rolled-out, the resources available to support the training approach, and a proposed training schedule, as well as developing a training follow-up planning by identifying post-transition re-training needs and the plan to address such needs. The communications team may be responsible for communicating transition messages such as sponsorship messages, transition activities, schedules, pilot success message, and post-transition activities. The communications team may further be responsible for champion coordination in creating sponsorship and ownership for transition and Claim Components within the office. The business process team may be responsible for the operational blueprint, that is how a claim office will operate in the target operational environment (processes, technology, roles).

The business content team may be responsible for the business content, that is defining what the system will enable the users to do (tasks, forms and correspondence, files notes, organization information). The system testing and conversion team may be responsible for model office testing (testing the system, training and team interaction in a mock claim office), the conversion approach used (defining what information will be converted and the procedures required to complete a conversion), and insuring that the application needs are fulfilled (i.e. reference tables, code/de-code, application components). The technical architecture team may be responsible for the operational readiness, that is the preparation and the organization's information technology department to support the new claims technology (technical help desk, performance monitoring, Microsoft solution support).

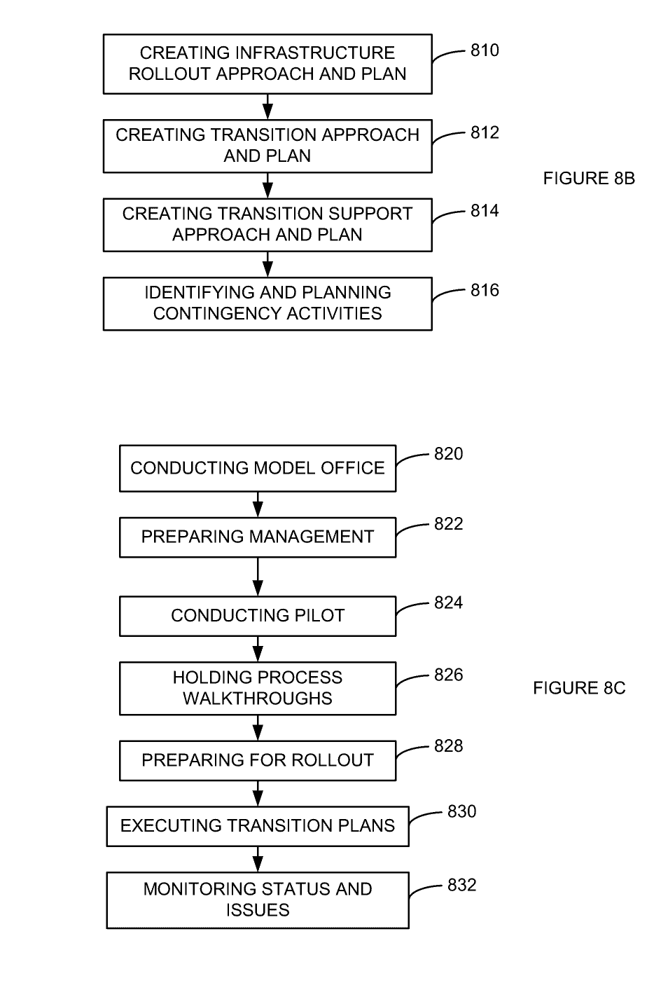

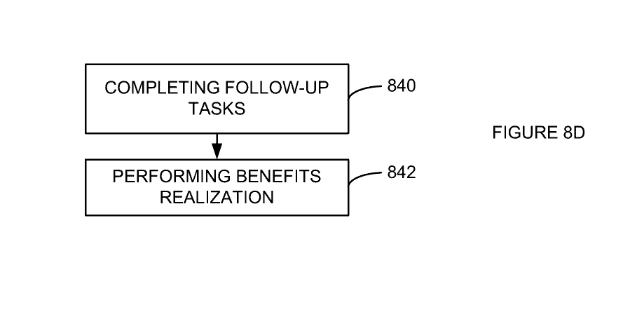

Methodology for performing the transition portion 212 is illustrated in FIG. 8A. As shown in FIG. 8A, transition planning is performed at step 802, roll-out is managed at step 804, and post-transition activities are completed at step 806.

Transition planning of step 802 encompasses a variety of decisions in details. The tasks completed and deliverables produced will serve as a foundation for the transition and will determine the ease by which the transition can be executed. It is important that the transition planning be as inclusive as possible. Key sponsors and the various project teams (training, communications, system testing and conversion, technical architecture, etc.) should participate in planning activities in order to set the stage for a smooth well-coordinated transition. In addition, it is important to have strong communication and coordination of activities with the claim office as many transition-related activities are dependent upon successful execution by the office management. Further detail for performing the transition planning step 802 is illustrated by the flowchart of FIG. 8B.

Using the Claim Components infrastructure, the target operational blueprint, the business content scope, the conversion approach, the training delivery approach and the impact assessment, transition planning is performed. Transition planning includes creating the infrastructure roll-out approach and plan as shown at step 810, creating a transition approach and plan at step 812, creating transition support approach and plan at step 814, and identifying and planning contingency activities as shown at step 816.

In creating the infrastructure roll-out approach and plan at step 810, the current equipment in the business organization offices and call centers (i.e. technological aspect 100 of FIG. 1) are verified to meet the minimum technical and equipment requirements for the target operational environment. In doing this, a process for installing new hardware with existing business organization software is required. Such a process includes conducting a site survey of the business organization, preparing the sites for the transition, piloting the equipment at the business organization and installing the equipment within the business organization. The site survey may be conducted by a surveyor and the claim office manager to determine the quantity and placement of the new equipment. Such a survey typically takes 2-3 hours. After conducting the survey, the number of servers, workstations and printers is usually agreed upon by the surveyor and the claim manager, and the results are compiled by the transition team, compared against target staffing numbers to validate the appropriate amount of equipment. Equipment purchases (where required) are scheduled, and the results are shared with regional management.

In site preparation, electrical/cabling work identified by the site survey is completed. The site preparation activity allows the claim office equipment installation to be completed as effectively as possible without affecting normal operations of the business organization. Site preparation is typically performed by the business organizations telecommunications department after normal business hours. Security and problem escalation procedures may be developed for this step.

Typically a pilot is conducted before the equipment roll-out ramps-up to full speed. A small number of offices (i.e. 1 or 2) are installed with the new equipment to validate that the equipment works properly with current systems of the business organization and that the training provided is sufficient for users to successfully function with the new equipment. A recommended time schedule for piloting is 3 to 4 weeks.

After the pilot insulation process is complete, the full implementation of the equipment may take place. A predetermined number of teams are usually assembled to complete the work. The length of implementing one office depends upon the difficulty of the installation and the number of new workstations (i.e. client computers 120 of FIG. 1) required. It is beneficial that the equipment installations occur after normal business hours and that the installation team leaves the office in working order for business the next day. Problems encountered should be resolved that night unless they are deemed to non-critical by the equipment coordinator and the claim office representative.

The resources for the roll-out effort are then defined. Such resources include members of the transition team including an equipment manager, surveyors and equipment coordinator(s), and a representative from the claim office that is a local equipment coach(es). The equipment manager coordinates all equipment installation related activities wherein the surveyors conduct the site surveys and the equipment coordinator prepares local equipment coaches for the night of the equipment installation. The equipment coordinator would walk the local equipment coach through the training materials and practice on the workstation once it is up and running. The local equipment coach is a representative from the claim office who is responsible for participating in the office installation and conducting training for the office the morning following the equipment installation.

Equipment training materials are typically developed to provide new equipment users with the skills required to access existing application through the target operational environment and equipment used therein. The equipment training development is coordinated usually with the training team. Materials include a pre-read document for the local equipment coach, a trainer's guide, detail training materials and a quick reference guide.

It is beneficial that potential candidates for the equipment coordinator and surveyor roles be identified as soon as possible as those jobs require extensive travel and after hours work. Because of the extensive travel and after hours work requirements, it may be difficult to identify the right resources necessary to fill these positions.

Prior to any site surveys or claim office visits, communications to the claim office management may be disseminated including information regarding key dates, activities and expectations. It is beneficial that required communications are coordinated with the communications team.

Through the equipment installation time period, questions may arise and technical support issues may be required to be solved. Accordingly, a support plan should be designed. The business organization's current support process and resources (i.e. help desk) should be analyzed to determine capacity and capability in resolving such technical support issues. After identifying the support mechanisms and resources, they should be prepared and trained for the equipment roll out.

After creating the infrastructure roll-out approach and plan of step 810, the transition approach and plan are created as shown at step 812. Transition teams' primary responsibility is to develop the overall transition approach. Included within this approach are the conversion approach, pilot and roll-out approach and roll-out schedule.

The conversion approach is the determination of what if anything will be converted from the existing system to the new target operational environment. Four pieces of information that can be converted include open claims, name and address book information, close claims and financial information.

Typically, conversion includes the conversion of open claims and name and address book information. The conversion of closed claims requires additional, significant post-conversion clean up efforts. Conversion of financial information is not recommended due to the conversion complexity and associated legal, audit and financial cycle timing risks.

Considerations in developing the pilot and roll-out approach include the pace of roll-out desired, and whether the roll-out will be split versus singular (for example Claim Components and Claim Financial may be implemented consecutively or simultaneously).

Split applications include roll-out pieces of Claim Components consecutively, and allows for system built and testing flexibility, and minimizes the amount of change employees experience at one time. However, split applications tend to require duplicate visits to the office/regions thereby increasing costs, and extend the transition timeline, in some cases requiring twice as long for the transition.

Singular applications occur where all pieces of Claim Components are rolled out simultaneously, allowing for a fast transition, thereby reducing costs as the number of office visits required are reduced. However, singular applications may be disadvantageous as the employees of the business organization experience a large amount of change at one time, and a large number of resources for system build and test is required.

Another consideration in pilot and roll-out approach is the roll-out method utilized. Roll-out methods include a single event (“Big Bang”) method, or a phased roll-out method. The pilot and single event (“Big Bang”) is a fast, cost effective method where all system users are moving according to the same schedule (milestones). However, such a roll-out method increases risk as there is no room for error in the transition, as well as increasing the risk of customer service impact and requiring a significant number of transition resources. Further, the training must be decentralized and executed in small chunks over a longer period of time, typically requiring extensive web-based training.

The pilot and phased roll out occurs where the pilot transition groups of offices. This roll out minimizes risks and allows for continuous improvement in the organization and for a customer service impact, while minimizing the number of transition resources required for the roll out. Further, the training team has options for this roll out method such as whether to conduct centralized or decentralized training and the training may be classroom based if desired. However, the pilot and phased roll out transition typically takes longer, and increase costs as a longer time frame for benefit realization results. Further, potential jurisdiction issues are raised such as sharing or reassignment of files between transitioned and non-transitioned offices.

The transition team in conjunction with project and claims management should evaluate the project objectives and the claim offices' capacity for change to determine the optimal pilot and roll out approach for the business organization.

After the pilot and roll out approach is defined, a detailed roll out schedule is created which lists the key dates and milestones for the transition. Considerations in generating the rollout schedule include the level of efforts necessary for each phase of the project (coding, testing, training development), seasonal claim patterns (peak time frames, catastrophic seasons, etc.), holiday weekends (i.e. the business organization may desire utilizing a three-day weekend to convert a single event approach is chosen), pilot activities and duration, and other company planned activities. The roll-out schedule should be used as a tool to communicate to other company projects. It should also be used as a tool in setting expectations for future activities with claims management.

Upon creating the transition approach and plan at step 812, the transition support approach and plan is then created as shown at step 814, where the transition support approach describes how the transition will be managed from a project prospective and how claim offices will be provided with adequate support. Components of the transition support approach may include a control center, transition guide, field support and help desk. The control center access a central hub of coordinating during transition events, including coordinating and reporting the status of all transition activities. The control center is responsible for management meetings, incident meetings, field support coordination, coordination of all systems and application conversion activities, updating status and facilitating conversion issues, resolution and work rounds. Considerations for planning the control center activities include developing control center processes by defining question escalation processes, communication procedures, issued escalation processes. Other considerations include developing tools to support the control center staff by creating control room orientation guides for staff and to define the control center operations, that is, the hours of operation, staffing schedule, and space preparation and equipment.

The transition guide covers all transition specific procedures which will have to be followed throughout the transition time line. The transition guide may be used to train managers and employees on the required conversion and transition events performed at each claim office. The transition guide typically includes a transition checklist and supporting procedures. The transition checklist is used as a tool for claim offices to guide them through conversion and transition activities and consists of various steps or tasks to successfully complete the transition activities for each day (or week). For example, at designated times, claim offices may be instructed to call the control room or send email acknowledging completion of a task or set of tasks.

Support procedures are detailed instructions for items listed within the transition checklist, such as “reserve a room for training classes”. The supporting procedures will list all the requirements for the room (equipment, cabling, office supplies, etc.) as well as who to contact with questions.

The field support resources are those who support transition activities in the claim offices and call centers, with responsibilities including supporting and monitoring the completion of key transition guide activities, answering general questions and providing assistance Claim Components users, escalating issues and difficult questions to project management and observing employee performance and comfort-level with Claim Components, as well as recommending follow-up training topics. Field support resources may be tightly integrated with training delivery plans and resources. Considerations in using the field support resources may include a number of field support resources required, usually based on a desired support per claim professional/administration ratio (25:1 is recommended), where field support resources will come from (pilot offices, project members, claim offices, etc.) and who will serve as the field support coordinator.

Planning for field support typically includes planning the travel, rental cars, beepers, corporate credit cards, calling cards, hotel accommodation, per diems and preparatory training. A field support coordinator should be assigned to the control room to manage the field support resources. The field support coordinator is typically responsible for meeting with the resources daily or bi-weekly to discuss progress and common issues of the claim office.

The help desk is a call center which provides managers and employees with answers to transition related questions, where the questions are typically categorized as either business or technical. The processes and resources used to address each category may vary. Typically the help desk staff is trained in advance so the claim offices and members of the transition team should be on-site with the help desk to resolve issues, answer additional questions, and monitor the number of types of calls received.

Once the transition support approach and plan are created at step 814, plan contingency activities are identified as shown at step 816. Identifying and planning contingency activities is the responsibility of the transition team. The project contingency plan provides a list of significant or critical issues that may surface throughout the transition timeline. Contingency planning requires considerations as to an action plan when a certain process has problems/is delayed/etc. Each of the teams typically develop the contingency plan.

The transition team typically develops a risk management template to distribute to all the teams where the template allows teams to enter their list of risk scenarios, along with the contingency plan to address each item and the probably that the risk would occur. Teams then submit their items back to transition team where they are combined and sorted in a single document. A sample risk management template may be provided by the Change Navigation Toolkit as a guide for creating the risk management template.

For each risk scenario deemed to have a high or medium business operation impact and a high or medium probability of occurring, a detailed contingency plan should be developed by the teams and submitted to transition team. The contingency plan is typically a mini-work plan including preventative measures to be undertaken to avoid the risk scenario, escalation processes to identify who will call the control center and describe the escalation decision, points and participants unique to the scenario, tasks including identifying impacted areas and systems, defining criteria for the decision making, detailing steps, step outfits, who will do it, and how long each step is expected to take, and associating risks with the resolution. Further contained in the contingency plan are tools including any tools used in resolution, and communication setting forth employee or customer communication requirements.

Contingency Days may be held where participants are given a set of scenarios for which to simulate contingency plans. The contingency scenarios better prepare the participants for any possibility that might arise as a result of the transition period reducing reaction times to problems and minimizing customer and employee impacts important to the success of the transition. Two contingency days are suggested, where the first day is internally focused with participation limited to project members, and the second day includes participants such as claim representatives, support units (help desk) and other potential resolution participants.

A process for the contingency days may include holding an initial meeting first thing in the morning to announce the scenarios, organizing the action team to deal with the problem, providing periodic update meetings (for example approximately every two hours) with transition team to review the status, and to wrap up meeting at the end of the day to evaluate action plans and discuss the lessons learned from the scenarios.

Returning to FIG. 8A, after performing transition planning at step 802, roll out is managed as shown at step 804. Managing the roll out is the execution of the transition plans, and utilizes the transition approach, transition support approach, training delivery plan, communications and sponsorship plans and contingency scenarios. Managing the roll out of step 804 is described in further detail in the flowchart of FIG. 8C.

As shown in FIG. 8C, managing the roll out is accomplished by conducting a model office at step 820, preparing management at step 822, conducting a pilot as shown at step 824, holding process walkthroughs at step 826, preparing for roll out at step 828, executing transition plans as shown at step 830 and monitoring the status and issues of the roll out at step 832.

Conducting the model office at step 820 allows for system, training and team interaction testing. To conduct a model office, a group of users within an office is selected to serve as model participants, and the users are trained on the business processing software of the desired operational environment, here Claim Components. Observations are made as to how the system support tasks, how the participants interact using the system and how effectively the training prepares the participants. The current transition plans are then improved to reflect the wisdom, lessons learned and best practices gained throughout the conducting of the model office.

Management, i.e. claims executives, regional management and office management, are prepared at step 822 to accept responsibility for transition success within the respective regions/office. Typically the transition team must provide management with the tools and information to feel comfortable accepting this responsibility. First, the mind set of management must be shifted by giving management information about how the system can transform their region/office and performance expectations based upon successful utilization of the new system operating under the target operational environment. For example, management may be apprised to the benefits of Claim Components increased search and reporting capabilities when file notes information is categorized. Management must understand such benefits and communicate the importance of capturing the full benefits of the system to their respective staff. Regional meetings, monthly office management meetings or communication vehicles may be utilized as forms that provide frequent and consistent “change management” messages and to set expectations.

As management is looked to for information and answers, it is important that management be educated, i.e. equipped with responses to the many questions that will result from transition activities. To that end, management must be educated in advanced of their staff regarding key transition tasks and procedures and general system knowledge. Web-conference calls, system demos and system prototypes may be utilized in providing this advanced knowledge.

After preparing the management at step 822, the pilot is conducted as shown at step 824. The pilot is a learning experience, which provides an opportunity for testing everything relating to the transition to the desired operational environment in an actual office. In conducting the pilot, it is important to assess the objectives for the pilot. Such objectives may include monitoring customer service impact resulting from transition activities, confirming claim component system performance, determining the effectiveness of the training program with all audiences, validating conversion procedures and processes, determining the effectiveness of champion preparation and support, evaluating the usefulness of the transition guide and evaluating project team coordination and preparedness. Further, key performance indicators are identified such as whether customer service standards were met, whether required transactions were supported by the new system, whether participants successfully converted a minimal of a pre-determined number of claim files during the training, whether champions were able to answer a predetermined percentage (for example 75%) of the questions asked of them, and whether the transition guide activities were completed accurately and on time. Critical success factors to be determined may include the office management support of project and pilot activities, pilot project team preparation and role definitions, clearly defined pilot scope and sufficient time for gathering and incorporating pilot feedback.

In selecting a pilot site, the office management support and office characteristics should be considered. Management sponsorship of both the project and transition activities is key to smooth pilot execution. Further, the size, location and number of lines of business and job representatives is an important consideration for the office characteristics, where a pilot should represent the total office population. Typically several options for pilot sites are identified and reviewed against the pilot objectives and critical success factors, and a recommendation for the pilot site(s) is presented to the project management.

Preparing for the pilot typically mirrors the full rollout of preparation activities including preparing trainers, champions and field support, preparing the control room staff, distributing training materials and the transition guide, and scheduling and preparing training facilities. The pilot is then conducted and monitored. Daily debrief meetings should occur to identify/resolve issues, discuss best practices and measure the pilot against key performance indicators. Feedback and lessons learned should be captured, evaluated and incorporated into future roll out efforts.

A successful pilot may be used as a showcase for the transition by communicating and demonstrating the results of the pilot to all sponsors and management, and obtaining sign-off for the pilot and the go-ahead for the full roll out.

After conducting the pilot as shown at step 824, process walkthroughs are held as shown at step 826. Holding process walkthroughs typically include two-three day working sessions conducted with claim representatives and project team members. Such sessions serve to share the target operational environment with office management and claim office representatives to brainstorm activities and methods management were used to ensure successful transition from each office's current state to the target environment. Some consideration for the walkthrough sessions include determining desired section outcomes, that is management accountability for office/region transition success, management understanding of the target environment, management support for revised processes and full utilization of the technology. Key session topic considerations include business case objectives, claims vision, system capabilities, revised business processes, staffing models, revised office roles, future transition activities, and management's role in the transition. Logistical considerations for the walkthroughs include regional sessions, date, participants, agenda, location, facilitators and communications.

Upon completion of the process walkthroughs at step 826, preparation for the full roll out begins, as shown at step 828. The trainers, champions and field support are prepared. The training delivery plan should have provided a means of preparing the transition support resources. Typically, three types of support resources include trainers, champions and field support. The trainers are responsible for conducting and supporting training activities within the claim offices. Trainer preparation typically includes a train the trainer session which includes presentation skills, facilitation skills, handling difficult participants and detailed instructions on Claim Components. Champions are typically responsible for serving as a liaison between the claim office and the project and for generating sponsorship and excitement for transition within his/her office. Champion preparation typically includes web-conferences with a presentation outlining key system benefits, system demonstrations and a preview of outcoming activities. Field support is responsible typically for supporting transition activities within the claim offices. Field support is typically prepared in training sessions which focus on transition guide activities and Claim Components knowledge.

While a training team is responsible for conducting and managing these sessions, transition teams should participate in any training topics related to the transition activities. For example, field support is responsible for managing the activities contained within the transition guide, the transition team should provide the training team with sample transition guides and facilitate a session with field support on how to use the guide.

Further, other preparation activities may include scheduling and training the control center staff on orientation guides. All status calls, tracking documents, contact lists, etc. should be developed and communicated. Additionally, any training materials, motivational items and transition guidelines should be distributed to appropriate audiences.

Once preparation activities have been completed at step 828, the transition plans should be executed within the claim offices according to the roll out schedule, as shown at step 830.

As the roll out progresses, monitoring the status and issues of the transition becomes the focus of the transition team. The status of the transition is monitored at step 832 for determining the completion of transition guide activities, completion of training activities, progress of files converted and branch management readiness. The mechanism for tracking each of these items is typically identified and monitored. As the status is known, it is typically communicated on a frequent basis to key sponsors and project management. Regarding issue resolution, issues must be quickly identified, understood and addressed. All issues should be tracked and managed via an issue log. Further, opportunities for continuous improvement are identified. Throughout the status and debrief meetings, lessons learned and best practices should be captured and shared with transition support resources to improve future transition and training activities.

Returning to FIG. 8A, once the roll out is managed at step 804, post-transition activities are completed as shown at step 806. Post-transition activities ensure that, not only is the Claim Component system being appropriately utilized, but also that it is embraced as the new way to work. Completing post-transition activities at step 806 is described in more detail with reference to FIG. 8D. Using the training follow up plan, post-transition activities are completed by completing the follow-up activities at step 840, and performing benefits realization as shown at step 842.

To complete the follow up activities at step 840, it is important to reinforce “shifting mindset” messages, as it was much more than a change of systems, it was a change to how claims staff work. Therefore, follow-up visits to reinforce this cultural change, as well as to ensure basic principles are understood and being leveraged is critical. Follow up activities for the office management may include ensuring that the people are utilizing the system effectively. This may be accomplished by observing the people and examining how long it is taking to execute activities in Claim Components, identifying if the correct activities are being performed in Claim Components, evaluating if the number of paper files requested is decreasing and evaluating the use of forms and correspondence. Further, an on-line audit may be performed as Claim Components has the ability to generate on-line reports. Generating different system utilization and using this capability provide statistics and facts regarding how the people of the business organization are leveraging the new functionality.

The transition/training teams may identify gaps and system utilization and user knowledge. These may be accomplished utilizing check points including a two-week check point where a scheduled meeting or conference call with management of each claim office and selected office representatives allow key issues and/or problems to be discussed as well as additional training needs to be identified. These check points may be utilized to resolve any issues, to schedule re-training sessions with offices to close knowledge gaps. A 60-90 day check point allows a follow up visit to be performed to each claim office to observe how employees are performing and utilizing the new system. Interviewing management and representative employees is useful in order to identify any continued or new issue as well as any additional retraining needs. A summary report is then created post-transition to be shared with the claims office management and project management. The report outlines the findings of each follow-up visit and the course of action being taken to address issues and retraining needs. Further, any activities outlined in the summary report course of action may be completed as well.

After completing follow-up activities of step 840, benefits realization is performed as shown at step 842. In performing the benefits realization, the expected benefits associated with the transition are measured against actual benefits realized. The business case should be reviewed and mechanisms are typically implemented to track associated benefits.

In the above discussion regarding transitioning the insurance claims business organization, it was described with regards to the business content portion that information (i.e. rules for handling claims processing employed in an event-based processor architecture) from templates is utilized by the Business Content team to populate the Claim Component libraries. In accordance with an alternative embodiment of the invention, the rules may be automatically extracted from the templates by a processor running on the personal computer accessing the Change Navigation Toolkit, as briefly discussed above with regards to FIG. 1B. In accomplishing this, it may be beneficial that the personal computer is in communication with the personal computer, network 122 of personal computers or server 101 on which the particular business processor software resides, in order to populate a library(ies) 150 of the business processor software with the extracted rules to be employed by the event processor 152.

The templates may be designed in a predetermined format, known by the processor at the personal computer accessing the Change Navigation Management, where the rules are extracted by the processor employing programming algorithms scanning the template for the rules. The processor is then capable of utilizing the rules to populate the respective library 150 of the event-based processor architecture with the proper rules for handling various events encountered by the event processor 152. The corresponding task(s) may then be retrieved by the task engine 154 and carried out by the task assistant 156.

In an alternative embodiment, the processor running on the personal computer accessing the Change Navigation Toolkit need not be in communication with the personal computer/network 122/server 101 running the business processing software, where the processor is capable of extracting the rules and populating the library(ies) 150 locally, for later downloading for use in the event-based business processing software.

Thus utilizing the systems and methodologies described herein, a business organization may be navigated to a desired operational environment more efficiently and effectively. Utilizing the Change Management Toolkit described herein, the change management may be planned from the beginning to the end of the transition, allowing for employees and management of the business organization, as well as related personnel, to be better prepared and excited about the transition to the desired environment. The education provided, as well as the on-going preparation of the employees, stakeholders, and/or management, further serve to prepare management and excite employees for the transition, and to gain support from within the organization for the transition, thereby resulting in an effective, supported transition of the organization. The ongoing assessments and training which may be provided prepares the employees and management for utilization of the full capabilities of the desired operational environment. The increased planning for the transition and determination and use of pilot testing sites reduces risks to the business organization in rolling out the full desired environment while ensuring that errors do not occur within the environment which may breach government regulations for the business organization or otherwise inconvenience the employees or clients of the business organization. Further, the budget planning described herein releases financial strain on the business organization by allowing proper preparation for the costs, from the beginning to the end of the transition, while reducing hidden or unexpected expenses.

The benefits just described are merely exemplary, as further benefits and advantages may be gained from utilizations of the teachings described herein. Further, in some circumstances, less than all of the teachings may be utilized while still attaining benefits and advantages.

The above description was mainly directed to an embodiment of the invention of transitioning an insurance claims organization to a desired operational environment utilizing Claims Components business processing software, where the various phases/portions of the Change Navigation Toolkit were described for the necessary planning and carrying out of the Claims Components software. However, one skilled would realize that some or all of the teachings, plannings, tasks, etc. described herein could be applied to, and used for, implementing any business process software for any business industry/organization in accordance with the methodologies described herein, and still fall within the scope of the invention.

While this invention has been shown and described in connection with a preferred embodiment, it is apparent that certain changes and modifications in addition to those mentioned above may be made from the basic features of this invention. In addition, there may be many different types of computer software and hardware that may be utilized for practicing the invention, and the invention is not limited to the examples described above. Accordingly, the described embodiments are to be considered in all respects only as illustrative and not restrictive, and the scope of the invention is therefore indicated by the appended claims rather than the foregoing description. All changes that come within the scope and range of the equivalency of the claims are to be embraced within their scope.

1. A system for transitioning a business organization from an existing operational environment to a target operational environment, the target operational environment operating using an automated computer system running business processing software employing an event-based methodology for carrying-out a business transaction process, the automated computer system including an event processor for handling events generated by the business processing software in accordance with a set of event rules and a rules library maintaining the set of event rules for use by the event processor in handling generated events, the system comprising:
an interactive implementation toolkit providing methodology and data structures for carrying-out the transition to the target operating environment, the data structures including templates for recording rules for handling events generated by the business processing software, and
a system processor capable of automatically extracting the rules from the template, and populating the rules library with the extracted rules.

2. The system of claim 1 wherein the data structures of the interactive implementation toolkit further comprise sample forms and correspondence, tasks, and file notes.

3. The system of claim 1 wherein the business organization is an insurance claims business organization, and the business processing software is software for use in the processing of insurance claims.

4. (canceled)

5. The system of claim 70, wherein the change navigation logic further causes the processor to display methodologies that
manage the transition of the business organization from the existing operational environment to the target operational environment, wherein the methodologies are selectable by the user for display.

6-9. (canceled)

10. The method of claim 71 wherein the transitioning the existing operational environment to the target operational environment further comprises:
planning a process walkthrough session to identify the business organization's existing operational environment;
conducting the process walkthrough session responsive to the planning; and
assessing an impact on the business organization of the transition to the target operational environment.

11. The method of claim 10 further comprising documenting and finalizing a To-Be process flow for the business organization responsive to the process walkthrough session.

12. The method of claim 10 wherein assessing the impact on the business organization includes:
identifying and categorizing a corresponding course of action to transition the business organization by at least one of affected business organization processes and affected business organization departments; and
determining a degree of change to the at least affected processes and departments.

13. The method of claim 12 further comprising rating the degree of change in accordance with a change scale.

14. The method of claim 13 further comprising developing a change strategy for the business organization responsive to the rating the degree of change.

15. The method of claim 10 further comprising validating and finalizing the impact assessment.

16. The method of claim 10 further comprising displaying on the computer display methodologies for generating and distributing messages to gain sponsorship for, and to keep members of the business organization informed about the transition to the target operational environment;
generating and distributing the messages to the members of the business organization;
designing and developing a sponsorship plan to gain and maintain sponsor support for the transition;
designing and developing a communication plan and communication materials to facilitate, support and promote the generated messages throughout the transition; and
assessing the effectiveness of the sponsorship plan, the communication plan, and communication materials.

17. The method of claim 16 wherein designing and developing the sponsorship plan includes selecting at least one sample sponsorship activity.

18. The method of claim 16 wherein assessing the effectiveness includes collecting feedback, and communicating the feedback to members of the business organization, in accordance with guidelines.

19. The method of claim 71 wherein customizing the first template includes:
defining and developing a business content approach for the business content;
establishing responsibilities for at least one business content librarian in developing and maintaining the business content after the transition;
gathering and finalizing the business content responsive to processes provided in the business content approach; and
loading and testing the business content on the automated computer system of the target operational environment.

20. The method of claim 19 further comprising defining future business content efforts including defining a scope of future business content efforts.

21. The method of claim 19 wherein defining and developing the business content approach includes defining business content objectives in accordance with guidelines.

22. The method of claim 19 wherein establishing responsibilities for at least one business content librarian includes utilizing business content librarian role descriptions and guidelines for selecting, and training the business content librarian.

23. The method of claim 19 wherein gathering and finalizing the business content includes identifying business organization personnel to participate in the business content validation and business content validation criteria in accordance with guidelines.

24. The method of claim 19 wherein loading and testing the business content includes loading the business content into the system and testing the business content in accordance with guidelines.

25. The method of claim 10 further comprising;
providing individuals impacted by the transition with knowledge, skills and performance support tools by:
determining a conceptual training design;
developing and validating a training program; and
determining a delivery approach for the training program.

26. The method of claim 25 wherein determining a conceptual training design includes:
identifying a training framework including a scope and an objective of the training program;
defining training audiences by identifying and categorizing individuals impacted by the transition into functionally-related groups of individuals;
identifying training requirements in accordance with the defined training audiences by determining a gap in skills between the existing operational environment and the target operational environment for each defined training audience;
creating a training curriculum by transforming the training requirements for each audience into corresponding training modules;
defining a training build plan describing an approach, timing and budget for management and development of a plurality of training modules and performance support tools;
developing the plurality of training modules and performance support tools; and
presenting the conceptual training design including the training build plan, and the plurality of training modules and performance support tools to appropriate business organization personnel impacted by the transformation for validation.

27. The method of claim 26 further comprising:
defining detailed learning objectives for each of the plurality of training modules;
designing training activities for each training module responsive to the detailed learning objectives;
generating a prototype training product to provide an indication as to a “look and feel” of at least one of the designed training activities;
developing training materials responsive to the prototype training product and feedback regarding the prototype training product; and
testing and finalizing the training materials.

28. The method of claim 25 wherein determining the delivery approach includes:
analyzing training audience rollout by determining a number of training resources required for the training program, modifications required for a training facility, and
a duration for training audience rollout;
creating a training schedule describing timing and activities associated with training audience rollout;
defining training preparation activities for training audience rollout including preparing support resources, and ensuring training facilities and equipment are coordinated; and
creating a training follow-up plan.

29. The method of claim 10 wherein transitioning the business organization to the target operating environment includes:
planning for transition to the target operational environment;
managing rollout of the target operational environment responsive to the planning for transition; and
conducting post-transition activities.

30. The method of claim 29 wherein planning for transition includes:
creating an infrastructure roll-out plan;
creating a transition roll-out plan;
creating a transition support plan; and
identifying and planning contingency activities.

31. The method of claim 29 wherein managing roll-out of the target operational environment includes:
conducting a model office;
preparing management of the business organization for transitioning to the target operational environment;
conducting a pilot of the target operational environment;
holding process walkthroughs;
preparing the business organization for transitioning to the target operational environment;
executing the transition to the target operational environment responsive to the planning for transition; and
determining and monitoring a status of the transition to the target operational environment.

32. The method of claim 29 wherein conducting post-transition activities includes:
performing follow-up activities in accordance with a predetermined time schedule; and
performing benefits realization of the target operational environment to the business organization.

33. The method of claim 32 wherein performing follow-up activities includes:
instructing business organization personnel to ensure that employees of the business organization are utilizing the target operational environment efficiently; and
identifying gaps between business organization employee knowledge of the target operational environment and capabilities of the target operational environment.

34. The method of claim 33 wherein instructing the business organizational personnel to ensure that employees of the business organization are utilizing the target operational environment efficiently includes:
instructing the business organization personnel on observing business organization employees utilization of the target operational environment; and
instructing the business organization personal on performing remote audits of the business organizations employee use of the target operational environment.

35. The method of claim 34 wherein the target operational environment includes a connection with the Internet, and the instructing the business organization personal on performing remote audits includes instructing the business organization personnel on performing remote audits using the Internet connection with the target operational environment.

36. (canceled)

37. The method of claim 10 wherein the transition is managed throughout the transition from the existing operational environment to the target operational environment, by:
creating a workplan and project timeline for the transition;
estimating a budget for the transition;
creating a team organization chart and role descriptions for team utilized in the transition;
establishing a status reporting process and issue log for a transition process; and
holding a team kick-off meeting and educational seminar for the teams utilized in the transition.

38. The method of claim 71 wherein the business organization is an insurance organization handling insurance claims processing.

39. (canceled)

40. The method of claim 71 further comprising developing business content by establishing a librarian to maintain the task library.

41. The method claim 71 wherein the first template is customized by automatically extracting the business content from at least one business content template having the first rule associated with the business event.

42. A method comprising:
transitioning, using an interactive implementation toolkit, an existing operational environment of an insurance claims business organization to a target operational environment for the insurance claims business organization, wherein:
the existing operational environment comprises existing claims processing software;
the interactive implementation toolkit comprises sample forms, correspondence, and file notes that facilitate an insurance claim handling process, and a plurality of respective templates that record business content to be implemented in the target operational environment; and
the transitioning of the existing operational environment to the target operational environment comprises:
a) providing on a computer display methodologies the target operational environment within the insurance claims business organization and a corresponding course of action required to transition the insurance claims business organization from the existing operational environment to the target operational environment, wherein the target operational environment comprises an automated computer system including new claims processing software that facilitates the insurance claim handling process;
b) providing on the computer display methodologies for generating and distributing messages to gain sponsorship for, and to keep members of the insurance claims business organization informed about the transition to the target operational environment;
c) providing on the computer display for selection by a user:
i) the sample forms, correspondence, and file notes, for facilitating implementation of the target operation environment, and after implementation, for improving efficiency of the insurance claim handling process; and
ii) a plurality of template links to a plurality of respective templates, including a first template link to a first template, wherein the first template includes data entry fields configured for receiving customized content associated with the insurance claim handling process;
d) selecting the first template link;
e) displaying the first template on the computer display;
f) customizing the first template via a processor by recording insurance claim handling business content received from the user in the data entry fields in the first template to create a customized template;
g) automatically associating the customized template via the processor with a first rule in the target operational environment, wherein the first rule is associated with an event that occurs in the insurance claim handling process;
h) communicating the first rule to a rules database within the automated computer system of the target operational environment wherein the customized template is in a predetermined format and the first rule that is extracted from the customized template is utilized to populate a task library stored in a memory for handling the business event, and a corresponding task is determined for the business event in accordance with the first rule maintained in the task library;
i) in response to the event, extracting, using the automated computer system, the first rule from the rules database and communicating the first rule to a task processor of the automated computer system, wherein when the task processor executes the first rule, the first rule causes the task processor to present on the computer display the customized template to be used in the insurance claims handling process in the target operational environment.

43. The method of claim 42 further comprising managing the transition of the insurance claim business organization throughout the transition from the existing operational environment to the target operational environment.

44. The method of claim 42 further comprising determining the corresponding course of action required to transition the business organization from the existing operational environment to the target operational environment by correlating functionality of the existing claims processing software to functionality provided by the new claims processing software.

45. The method of claim 42 wherein the methodologies for defining the target operational environment include assessing an impact on the insurance claims business organization of the transition from the existing operational environment to the target operational environment.

46. The method of claim 45 wherein the assessing the impact on the insurance claims business organization includes rating the impact of the transition in accordance with a rating system provided by the interactive implementation toolkit.

47. The method of claim 46 further comprising generating a prioritized list of changes to implement the target operational environment responsive to the rating the impact, identifying a preferred order of implementing the changes.

48. (canceled)

49. The method of claim 42, wherein communicating the first rule to the rules database further comprises establishing a librarian within the automated computer system to maintain the task library.

50. (canceled)

51. A method for instructing a member of a business organization implementing an automated computer system for processing business transactions in a target operational environment, the members of the business organization using an interactive implementation navigation toolkit, the method comprising:
a) displaying a list of various steps in the implementation process on a display screen of a computer system;
b) allowing the user to randomly select one of the steps on the displayed list;
c) displaying a description of the step and at least one of a plurality of first graphical icons and first hyperlinked text, the at least first icon and hyperlinked text representing at least one of an additional step, and sub-step thereof for the selected step;
d) displaying at least one of a plurality of second graphical icons and second hyperlinked text, the at least second icons and hyperlinked text representing
i) sample deliverables, including sample forms and correspondence, and file notes, to facilitate the implementation of the target operation environment, and after implementation, for improving efficiency of the business transaction process; and
ii) sample deliverables including integrated templates for recording information to be used in existing operational environment to the target operational environment; and
e) in response to the user selection of at least one of the first and second icons and hyperlinked text, providing the description of at least the step, sub-step, and sample deliverables corresponding to said respective icon or hyperlinked text.

52. The method of claim 51, further comprising, importing at least one of the sample deliverables into an application program operating on a client system, customizing the sample deliverable or template according to the target operational environment, and using the customized deliverable for the implementation of the target operational environment.

53. The method of claim 52 further comprising, automatically importing data entered into the sample deliverable template into the automated computer system.

54. The method of claim 51 wherein displaying a list of various steps in the implementation process includes:
a) displaying an option to define the target operational environment within the business organization and a corresponding course of action required to transition the business organization to the target operational environment;
b) displaying an option to generate and distribute messages to gain sponsorship for, and to keep members of the business organization informed about the transition;
c) displaying an option to develop business content, including at least customized tasks, forms and correspondence, file notes and organizational data to be loaded into the automated computer system for use in operating the business organization in the target operational environment;
d) displaying an option to provide individuals impacted by the transition with the knowledge, skills and performance support tools for performing within the target operational environment; and
e) displaying an option to transition the business organization to the target operational environment.

55. The method of claim 54 wherein displaying a list of various steps in the implementation process further includes displaying an option to manage the transition to the target operational environment.

56. A method of managing the implementation of an automated computer system of a business organization using an interactive implementation toolkit by facilitating transformation of a knowledge worker workforce, comprising:
defining a target operational environment of the business organization including target business processes for the business organization, workforce performance measurements at least one of during and after the transition, workforce skill enhancements for operating in, and job reclassification for, the target operational environment, and a management reporting, while accounting for capabilities of the automated computer system;
instructing management on techniques for encouraging employee commitment to transformation of the business organization, including instruction of creating and distributing messages for gaining sponsorship of the transformation and messages providing information regarding the transformation of the business organization to at least one of the workforce, sponsors and stakeholders of the business organization;
developing customized tasks, forms and correspondence, file notes, and organizational data for use in the automated computer system of the target operational environment for supporting the transformation of job responsibilities, and for providing at least one of any the workforce, sponsors and stakeholders of the business organization and personnel related to the business organization with knowledge, skills and performance tools for performing in the target operational environment; and
creating a plan for transitioning the business organization and workforce to the target operational environment.

57. The method of claim 56 wherein the workforce may include at least one of the sponsors and the stakeholders.

58. The method of claim 56 wherein defining the target operational environment includes generating To-Be process flows.

59. The method of claim 56 further comprising uploading the customized tasks, forms and correspondence, file notes, and organizational data to the automated computer system.

60. The method of claim 56 further comprising transitioning the business organization to the target operational environment.

61. The method of claim 60 wherein the transitioning the business organization to the target operational environment includes transitioning the business organization to the target operational environment responsive to the plan.

62. A method for configuring a computer system for a target operational environment, the method comprising:
(a) establishing, in a first memory, templates comprising predetermined rules for handling events that may occur in predetermined target operational environments;
(b) establishing, in a second memory in a computer system under configuration, a task library for locally storing event handling rules;
(c) determining a specific target operational environment for the computer system;
(d) accessing the templates in the first memory; and
(e) using a processor m the computer system, automatically extracting selected predetermined rules from the templates for handling the events that may occur in the specific target operational environment, and populating the task library with the extracted rules.

63. The method of claim 62, where accessing the templates comprises accessing templates remotely stored on a website.

64. The method of claim 62, where the templates comprise insurance claim templates, and where the extracted rules handle insurance claim processing events.

65. The method of claim 62, where the computer system comprises a server connected to client computers, and where the server comprises the task library, an event processor, and a task engine that receives an occurring event from the event processor and determines an applicable rule in the task library for the occurring event.

66. The system of claim 1, further comprising a remotely located website comprising the templates.

67. The system of claim 66, where the templates comprise insurance claim templates, and where the extracted rules handle insurance claim processing events.

68. The system of claim 67, where the computer system further comprises:
a server comprising the rules library, the event processor, and a task engine that receives an insurance claim processing event from the event processor and determines an applicable rule in the rules library for the insurance claim processing event; and
client computers connected to the server.

69. The system of claim 1, where the computer system further comprises:
a server comprising the rules library, the event processor, and a task engine that receives an occurring event from the event processor and determines an applicable rule in the rules library for the occurring event; and
client computers connected to the server.

70. A system comprising:
a computer processor;
a computer display in communication with the processor; and
a computer readable storage medium in communication with the processor, wherein the computer readable storage medium comprises change navigation logic, which when executed by the computer processor causes the processor to:
provide on the computer display methodologies for transitioning, using an interactive toolkit, an existing operational environment of a business organization to a target operational environment for the business organization, wherein:
the existing operational environment comprises existing business processing software; and
the interactive implementation toolkit comprises:
sample forms, correspondence, and file notes that facilitate a business process of the business organization, and
a plurality of respective templates that record business content to be implemented in the target operational environment;
provide on the computer display methodologies for defining the target operational environment within the business organization and a corresponding course of action required to transition the business organization from the existing operational environment to the target operational environment, wherein the target operational environment comprises an automated computer system including new business processing software that carries out the business process in the target operational environment;
provide on the computer display methodologies for generating and distributing messages to gain sponsorship for, and to keep members of the business organization informed about the transition to the target operational environment;
provide on the computer display for selection by a user:
the sample forms, correspondence, and file notes, that facilitate implementation of the target operational environment, and after implementation, for improving efficiency of the business process; and
a plurality of template links to the plurality of respective templates, including a first template link to a first template, wherein the first template includes data entry fields that receive customized content associated with a business event that occurs in the business process;
in response to user selection of the first template link, present the first template on the display;
customize the first template by recording business content received from the user in the data entry fields in the first template to create a customized template;
automatically associate the customized template with a first rule in the target operational environment, wherein the first rule is associated with the business event;
communicate the first rule to a rules database within the automated computer system of the target operational environment, and wherein the customized template is in a predetermined format and the first rule that is extracted from the customized template is utilized to populate a task library stored in a memory for handling the business event, and a corresponding task is determined for the business event in accordance with the first rule maintained in the task library; and
in response to the to the business event, trigger the automated computer system of the target operational environment to:
extract the first rule from the rules database and communicate the first rule to a task processor of the automated computer system, and wherein, when the task processor executes the first rule, the first rule causes the task processor to present on the computer display the customized template to be used in the business process in the target operational environment.

71. A method comprising:
transitioning, using an interactive implementation toolkit, an existing operational environment of a business organization to a target operational environment for the business organization, wherein:
the existing operational environment comprises existing business processing software;
the interactive implementation toolkit comprises:
sample forms, correspondence, and file notes that facilitate a business process, and
a plurality of respective templates that record business content to be implemented in the target operational environment; and
the transitioning the existing operational environment to the target operational environment comprises:
a) providing on a computer display methodologies for defining the target operational environment within the business organization and a corresponding course of action required to transition the business organization from the existing operational environment to the target operational environment, wherein the target operational environment comprises an automated computer system including new business processing software that carries out the business process;
b) providing on the computer display methodologies for generating and distributing messages to gain sponsorship for, and to keep members of the business organization informed about the transition to the target operational environment;
c) providing on the computer display for selection by a user:
i) the sample forms, correspondence, and file notes, that facilitate implementation of the target operational environment, and after implementation, for improving efficiency of the business process;
ii) a plurality of template links to the plurality of respective templates, including a first template link to a first template, wherein the first template includes data entry fields that receive customized content associated with a business event that occurs in the business process;
d) receiving a user selected first template link;
e) displaying on the computer display the first template in response to user selection of the first template link;
f) customizing the first template via a processor by recording business content received from the user in the data entry fields in the first template to create a customized template;
g) automatically associating the customized template via the processor with a first rule in the target operational environment, wherein the first rule is associated with the business event; and
e) communicating the first rule to a rules database within the automated computer system of the target operational environment;
wherein the customized template is in a predetermined format and the first rule that is extracted from the customized template is utilized to populate a task library stored in a memory for handling the business event, and a corresponding task is determined for the business event in accordance with the first rule maintained in the task library; and
wherein, in response to the business event, the automated computer system of the target operational environment extracts the first rule from the rules database and communicates the first rule to a task processor of the automated computer system, and wherein, when the task processor executes the first rule, the first rule causes the task processor to present on the computer display the customized template to be used in the business process in the target operational environment.
